(19) United States
(12) Patent Application Publication
(10) Pub. No.: US 2023/0362953 A1
(43) Pub. Date: Nov. 9, 2023

(54) DOWNLINK CONTROL INFORMATION FOR UPLINK SCHEDULING

(71) Applicants: Fang YUAN, San Diego, CA (US); Changlong XU, San Diego, CA (US); Wooseok NAM, San Diego, CA (US); Xiaxia ZHANG, San Diego, CA (US); Tao LUO, San Diego, CA (US); QUALCOMM INCORPORATED, San Diego, CA (US)

(72) Inventors: Fang YUAN, Beijing (CN); Changlong XU, Beijing (CN); Wooseok NAM, San Diego, CA (US); Xiaoxia ZHANG, San Diego, CA (US); Tao LUO, San Diego, CA (US)

(21) Appl. No.: 17/797,553

(22) PCT Filed: Mar. 26, 2020
(86) PCT No.: PCT/CN2020/081467

§ 371 Date: Aug. 4, 2022

(51) Int. Cl. H04W 72/232; H04W 72/044; H04L 5/00

(52) U.S. Cl. CPC H04W 72/232; H04W 72/044; H04L 5/0053

(57) ABSTRACT

Methods, systems, and devices for wireless communications are described. In some systems, abase station may transmit multiple related downlink control information (DCI) transmissions to a user equipment (UE). The base station may transmit a first DCI in a control resource set (CORESET) and may transmit the second DCI in a configured physical downlink shared channel (PDSCH) occasion. The UE may determine the payload and the location of the second DCI for receiving the second DCI based on control signaling from the base station or based on the first DCI, or both. Accordingly, the UE may receive the first DCI and the second DCI and may transmit an uplink transmission to the base station in accordance with the first DCI and the second DCI.

### CROSS REFERENCE

The present application is a 371 national stage filing of International PCT Application No. PCT/CN2020/081467 by YUAN et al. entitled “DOWNLINK CONTROL INFORMATION FOR UPLINK SCHEDULING,” filed Mar. 26, 2020, which is assigned to the assignee hereof, and which is expressly incorporated by reference in its entirety herein.

### FIELD OF TECHNOLOGY

The following relates generally to wireless communications and more specifically to downlink control information for uplink scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a base station may transmit control information to a user equipment (UE) to schedule one or more data transmissions between the base station and the UE. Such control information may be transmitted via downlink control information (DCI), which may be associated with a limited size. As demand for greater throughput increases, a base station may transmit more control information than may fit within a single DCI. Improved techniques for transmitting an increasing amount of control information are desired.

### SUMMARY

The described techniques relate to improved methods, systems, devices, and apparatuses that support downlink control information for uplink scheduling. Generally, the described techniques provide for receiving multi-part downlink control information (DCI) at a user equipment (UE) where a second dependent DCI may be received on a physical downlink shared channel (PDSCH) for uplink scheduling. In some examples, the UE may receive a two-part DCI including separate occasions for a first DCI and a second DCI, where the second DCI may include control information relating to or corresponding to control information included in the first DCI. The UE may receive the first DCI via a control resource set (CORESET) and the UE may receive the second DCI via a shared data channel occasion, such as a PDSCH occasion.

To enable the UE to determine the location of the shared data channel occasion in which the UE may receive the second DCI, the base station may transmit control signaling to the UE that may provide the UE with information associated with the location or configuration of the shared data channel occasion. In some examples, the information provided by the control signaling may include a set of resources (e.g., time and frequency resources) for the shared data channel occasion, a time-domain offset of the shared data channel occasion relative to the location of the first DCI, a modulation order associated with the shared data channel occasion, a demodulation reference signal (DMRS) configuration of the shared data channel occasion, a code rate associated with the shared data channel occasion, or a combination thereof, among other examples. Additionally or alternatively, the UE may determine the location or size of the shared data channel occasion based on information within the first DCI. For example, the UE may determine the shared data channel occasion based on an index in the first DCI, an aggregation level of the first DCI, or an index of a first control channel element (CCE) occupied by the first DCI, among other examples.

As such, the UE may receive the first DCI in the CORESET and the second DCI in the shared data channel occasion and may determine scheduling information based on decoding the first DCI and the second DCI. In some examples, the UE may determine scheduling information associated with an uplink transmission and may transmit the uplink transmission in accordance with the first DCI and the second DCI.

A method of wireless communications by a UE is described. The method may include receiving control signaling configuring the UE with a shared data channel occasion, receiving first DCI via a CORESET, receiving second DCI via the shared data channel occasion, and transmitting an uplink transmission in accordance with the first DCI and the second DCI.

An apparatus for wireless communications by a UE is described. The apparatus may include a processor, memory coupled with the processor, and instructions stored in the memory. The instructions may be executable by the processor to cause the apparatus to receive control signaling configuring the UE with a shared data channel occasion, receive first DCI via a CORESET, receive second DCI via the shared data channel occasion, and transmit an uplink transmission in accordance with the first DCI and the second DCI.

Another apparatus for wireless communications by a UE is described. The apparatus may include means for receiving control signaling configuring the UE with a shared data channel occasion, receiving first DCI via a CORESET, receiving second DCI via the shared data channel occasion, and transmitting an uplink transmission in accordance with the first DCI and the second DCI.

A non-transitory computer-readable medium storing code for wireless communications by a UE is described. The code may include instructions executable by a processor to receive control signaling configuring the UE with a shared data channel occasion, receive first DCI via a CORESET, receive second DCI via the shared data channel occasion, and transmit an uplink transmission in accordance with the first DCI and the second DCI.

In some examples of the method, apparatuses, and non-transitory computer-readable medium described herein, receiving the second DCI may include operations, features, means, or instructions for receiving the second DCI that may have a payload size that may be dependent on the first DCI.

In some examples of the method, apparatuses, and non-transitory computer-readable medium described herein, receiving the control signaling may include operations, features, means, or instructions for receiving the control signaling that indicates a time domain resource allocation, a frequency domain resource allocation, or both, for the shared data channel occasion.

In some examples of the method, apparatuses, and non-transitory computer-readable medium described herein, receiving the control signaling may include operations, features, means, or instructions for receiving the control signaling that indicates the time domain resource allocation that indicates one or more symbol periods, the frequency domain resource allocation that indicates one or more resource blocks, or both, for the shared data channel occasion.

In some examples of the method, apparatuses, and non-transitory computer-readable medium described herein, receiving the control signaling may include operations, features, means, or instructions for receiving the control signaling that indicates an offset for the shared data channel occasion relative to a location of the first DCI in the CORESET, where the second DCI may be received based on the offset.

In some examples of the method, apparatuses, and non-transitory computer-readable medium described herein, receiving the control signaling may include operations, features, means, or instructions for receiving the control signaling that indicates a modulation order configured for the shared data channel occasion, where the second DCI may be received based on the modulation order.

In some examples of the method, apparatuses, and non-transitory computer-readable medium described herein, receiving the control signaling may include operations, features, means, or instructions for receiving the control signaling that indicates a DMRS configuration configured for the shared data channel occasion, where the second DCI may be received based on the DMRS configuration.

In some examples of the method, apparatuses, and non-transitory computer-readable medium described herein, receiving the first DCI may include operations, features, means, or instructions for performing blind decoding of one or more search spaces in the CORESET to decode the first DCI, where the shared data channel occasion may be decoded based on successful decoding of the first DCI.

In some examples of the method, apparatuses, and non-transitory computer-readable medium described herein, receiving the control signaling may include operations, features, means, or instructions for receiving the control signaling indicating that the second DCI may be communicated within at least a subset of a set of resource blocks allocated for the shared data channel occasion.

In some examples of the method, apparatuses, and non-transitory computer-readable medium described herein, receiving the control signaling may include operations, features, means, or instructions for receiving the control signaling indicating that the second DCI may be communicated within all of the set of resource blocks allocated for the shared data channel occasion.

In some examples of the method, apparatuses, and non-transitory computer-readable medium described herein, receiving the first DCI may include operations, features, means, or instructions for receiving the first DCI that includes an index that indicates a first resource block subset of the set of resource blocks in which the second DCI may be communicated.

In some examples of the method, apparatuses, and non-transitory computer-readable medium described herein, receiving the control signaling may include operations, features, means, or instructions for receiving the control signaling that indicates a code rate configured for the shared data channel occasion, and deriving the subset of the set of resource blocks in which the second DCI may be communicated based on the code rate.

In some examples of the method, apparatuses, and non-transitory computer-readable medium described herein, the second DCI may be rate matched on at least a subset of a set of resource blocks allocated for the shared data channel occasion.

In some examples of the method, apparatuses, and non-transitory computer-readable medium described herein, receiving the control signaling configuring the UE with the shared data channel occasion may include operations, features, means, or instructions for receiving the control signaling configuring the UE with a first shared data channel occasion and a second shared data channel occasion within a shared data channel, where the second DCI may be received within one of the first shared data channel occasion or the second shared data channel occasion based on the first DCI.

In some examples of the method, apparatuses, and non-transitory computer-readable medium described herein, the second DCI may be received within one of the first shared data channel occasion or the second shared data channel occasion based on an aggregation level of the first DCI.

In some examples of the method, apparatuses, and non-transitory computer-readable medium described herein, the second DCI may be received within one of the first shared data channel occasion or the second shared data channel occasion based on a starting index of a CCE of the first DCI.

In some examples of the method, apparatuses, and non-transitory computer-readable medium described herein, the second DCI may be received within one of the first shared data channel occasion or the second shared data channel occasion based on a payload size of the second DCI that corresponds to the first DCI.

In some examples of the method, apparatuses, and non-transitory computer-readable medium described herein, the second DCI may be received within one of the first shared data channel occasion or the second shared data channel occasion based on an index indicated in the first DCI.

Some examples of the method, apparatuses, and non-transitory computer-readable medium described herein may further include operations, features, means, or instructions for performing polar decoding on the CORESET to obtain the first DCI, and performing polar decoding on the shared data channel occasion to obtain the second DCI.

Some examples of the method, apparatuses, and non-transitory computer-readable medium described herein may further include operations, features, means, or instructions for performing polar decoding on the CORESET to obtain the first DCI, and performing low density parity check decoding on the shared data channel occasion to obtain the second DCI.

In some examples of the method, apparatuses, and non-transitory computer-readable medium described herein, the first DCI and the second DCI may be received within a same transmission time interval.

A method of wireless communications by a base station is described. The method may include transmitting control signaling configuring the UE with a shared data channel occasion, transmitting first DCI via a CORESET, transmitting second DCI via the shared data channel occasion, and receiving an uplink transmission in accordance with the first DCI and the second DCI.

An apparatus for wireless communications by a base station is described. The apparatus may include a processor, memory coupled with the processor, and instructions stored in the memory. The instructions may be executable by the processor to cause the apparatus to transmit control signaling configuring the UE with a shared data channel occasion, transmit first DCI via a CORESET, transmit second DCI via the shared data channel occasion, and receive an uplink transmission in accordance with the first DCI and the second DCI.

Another apparatus for wireless communications by a base station is described. The apparatus may include means for transmitting control signaling configuring the UE with a shared data channel occasion, transmitting first DCI via a CORESET, transmitting second DCI via the shared data channel occasion, and receiving an uplink transmission in accordance with the first DCI and the second DCI.

A non-transitory computer-readable medium storing code for wireless communications by a base station is described. The code may include instructions executable by a processor to transmit control signaling configuring the UE with a shared data channel occasion, transmit first DCI via a CORESET, transmit second DCI via the shared data channel occasion, and receive an uplink transmission in accordance with the first DCI and the second DCI.

In some examples of the method, apparatuses, and non-transitory computer-readable medium described herein, transmitting the second DCI may include operations, features, means, or instructions for transmitting the second DCI that may have a payload size that may be dependent on the first DCI.

In some examples of the method, apparatuses, and non-transitory computer-readable medium described herein, transmitting the control signaling may include operations, features, means, or instructions for transmitting the control signaling that indicates a time domain resource allocation, a frequency domain resource allocation, or both, for the shared data channel occasion.

In some examples of the method, apparatuses, and non-transitory computer-readable medium described herein, transmitting the control signaling may include operations, features, means, or instructions for transmitting the control signaling that indicates the time domain resource allocation that indicates one or more symbol periods, the frequency domain resource allocation that indicates one or more resource blocks, or both, for the shared data channel occasion.

In some examples of the method, apparatuses, and non-transitory computer-readable medium described herein, transmitting the control signaling may include operations, features, means, or instructions for transmitting the control signaling that indicates an offset for the shared data channel occasion relative to a location of the first DCI in the CORESET, where the second DCI may be transmitted based on the offset.

In some examples of the method, apparatuses, and non-transitory computer-readable medium described herein, transmitting the control signaling may include operations, features, means, or instructions for transmitting the control signaling that indicates a modulation order configured for the shared data channel occasion, where the second DCI may be transmitted based on the modulation order.

In some examples of the method, apparatuses, and non-transitory computer-readable medium described herein, transmitting the control signaling may include operations, features, means, or instructions for transmitting the control signaling that indicates a DMRS configuration configured for the shared data channel occasion, where the second DCI may be transmitted based on the DMRS configuration.

In some examples of the method, apparatuses, and non-transitory computer-readable medium described herein, transmitting the control signaling may include operations, features, means, or instructions for transmitting the control signaling indicating that the second DCI may be communicated within at least a subset of a set of resource blocks allocated for the shared data channel occasion.

In some examples of the method, apparatuses, and non-transitory computer-readable medium described herein, transmitting the control signaling may include operations, features, means, or instructions for transmitting the control signaling indicating that the second DCI may be communicated within all of the set of resource blocks allocated for the shared data channel occasion.

In some examples of the method, apparatuses, and non-transitory computer-readable medium described herein, transmitting the first DCI may include operations, features, means, or instructions for transmitting the first DCI that includes an index that indicates a first resource block subset of the set of resource blocks in which the second DCI may be communicated.

In some examples of the method, apparatuses, and non-transitory computer-readable medium described herein, transmitting the control signaling may include operations, features, means, or instructions for transmitting the control signaling that indicates a code rate configured for the shared data channel occasion.

In some examples of the method, apparatuses, and non-transitory computer-readable medium described herein, the second DCI may be rate matched on at least a subset of a set of resource blocks allocated for the shared data channel occasion.

In some examples of the method, apparatuses, and non-transitory computer-readable medium described herein, transmitting the control signaling configuring the UE with the shared data channel occasion may include operations, features, means, or instructions for transmitting the control signaling configuring the UE with a first shared data channel occasion and a second shared data channel occasion within a shared data channel, where the second DCI may be transmitted within one of the first shared data channel occasion or the second shared data channel occasion based on the first DCI.

In some examples of the method, apparatuses, and non-transitory computer-readable medium described herein, the second DCI may be transmitted within one of the first shared data channel occasion or the second shared data channel occasion based on an aggregation level of the first DCI.

In some examples of the method, apparatuses, and non-transitory computer-readable medium described herein, the second DCI may be transmitted within one of the first shared data channel occasion or the second shared data channel occasion based on a starting index of a CCE of the first DCI.

In some examples of the method, apparatuses, and non-transitory computer-readable medium described herein, the second DCI may be transmitted within one of the first shared data channel occasion or the second shared data channel occasion based on a payload size of the second DCI that corresponds to the first DCI.

In some examples of the method, apparatuses, and non-transitory computer-readable medium described herein, the second DCI may be transmitted within one of the first shared data channel occasion or the second shared data channel occasion based on an index indicated in the first DCI.

Some examples of the method, apparatuses, and non-transitory computer-readable medium described herein may further include operations, features, means, or instructions for performing polar encoding of the first DCI to generate a first one or more codewords, where transmitting the first DCI includes transmitting the first one or more codewords, and performing polar encoding of the second DCI to generate a second one or more codewords, where transmitting the second DCI includes transmitting the second one or more codewords.

Some examples of the method, apparatuses, and non-transitory computer-readable medium described herein may further include operations, features, means, or instructions for performing polar encoding of the first DCI to generate a first one or more codewords, where transmitting the first DCI includes transmitting the first one or more codewords, and performing low density parity check encoding of the second DCI to generate a second one or more codewords, where transmitting the second DCI includes transmitting the second one or more codewords.

In some examples of the method, apparatuses, and non-transitory computer-readable medium described herein, the first DCI and the second DCI may be transmitted within a same transmission time interval.

### BRIEF DESCRIPTION OF THE DRAWINGS

FIG. 1 illustrates an example of a wireless communications system in accordance with aspects of the present disclosure.

FIG. 2 illustrates an example of a wireless communications system in accordance with aspects of the present disclosure.

FIGS. 3A, 3B, and 3C illustrate example DCI configurations in accordance with aspects of the present disclosure.

FIG. 4 illustrates an example of a process flow in accordance with aspects of the present disclosure.

FIGS. 5 and 6 illustrate block diagrams of devices in accordance with aspects of the present disclosure.

FIG. 7 illustrates a block diagram of a communications manager in accordance with aspects of the present disclosure.

FIG. 8 illustrates a diagram of a system including a device in accordance with aspects of the present disclosure.

FIGS. 9 and 10 illustrate block diagrams of devices in accordance with aspects of the present disclosure.

FIG. 11 illustrates a block diagram of a communications manager in accordance with aspects of the present disclosure.

FIG. 12 illustrates a diagram of a system including a device in accordance with aspects of the present disclosure.

FIGS. 13 through 22 illustrate flowcharts showing methods in accordance with aspects of the present disclosure.

### DETAILED DESCRIPTION

As demand for communication resources increases due to an increasing number of wireless devices communicating over the available spectrum, techniques to efficiently and reliably increase throughput are desirable. For example, some wireless communications systems may allow for the transmission of control information that may exceed a payload size associated with individual downlink control information (DCI) transmissions, such as a DCI payload size as defined in a specification, to enable a base station to schedule a greater amount of resources or provide a greater amount of configuration information at a user equipment (UE). As described herein, the base station may transmit the control information to the UE via multiple related DCIs. The UE may expect to receive DCI by monitoring and decoding a control resource set (CORESET) of a downlink control channel. In some cases, however, the base station may be unable or may otherwise refrain from transmitting multiple DCIs within a single CORESET. Instead, the base station may transmit a first portion of the control information in DCI via the CORESET and may transmit a second portion of the control information in DCI via a data channel, such as a shared data channel (e.g., a physical downlink shared channel (PDSCH)). For example, the base station may transmit a first DCI in an occasion within the CORESET and may transmit a second DCI in an occasion within the shared data channel. Although such use of multiple (e.g., two) DCI transmissions may enable the base station to transmit greater amounts of control signaling to the UE, the techniques described herein may inform a UE of when and how to receive and decode the second DCI carried by the shared data channel.

In some implementations of the present disclosure, the UE may receive control signaling, such as radio resource control (RRC) signaling, that includes information associated with the location or configuration of the second DCI carried by the shared data channel. In some examples, the UE may determine a resource allocation (e.g., time and frequency), an offset relative to a location of the first DCI in the CORESET, a modulation order, a DMRS configuration, or a code rate associated with a shared data channel occasion in which the UE may receive the second DCI, and the UE may receive and decode the second DCI accordingly. Additionally or alternatively, the UE may be configured to determine a shared data channel occasion in which the UE may receive the second DCI based on receiving the first DCI. For example, the UE may identify one or more indications within the first DCI (e.g., an index or a number of bits) or characteristics of the first DCI (e.g., a location in the frequency domain) and the UE may determine the location of the second DCI based on the indications within the first DCI or the characteristics of the first DCI.

Particular aspects of the subject matter described herein may be implemented to realize one or more potential advantages. The described techniques may support improvements in systems supporting multiple related DCIs that may enable a base station to efficiently transmit greater amounts of control information to a UE. For example, by implementing some of the techniques described herein, the UE may determine the location of a second DCI within a shared data channel. As such, the UE and the base station may achieve higher data rates and increase the capacity for communications between the UE and the base station. Additionally, the possibility of greater amounts of control information may provide a system with more efficient resource usage, which may improve the spectral efficiency and throughput of the system. Moreover, by enabling the UE to receive a second DCI within a shared data channel, the UE may potentially refrain from monitoring additional CORESETs for any additional control information, which may enable the allocation of fewer control resources and, in some cases, the allocation of more data resources that may be used to increase data throughput.

Aspects of the disclosure are initially described in the context of wireless communications systems. Aspects of the disclosure are additionally described in the context of DCI configurations and a process flow. Aspects of the disclosure are further illustrated by and described with reference to apparatus diagrams, system diagrams, and flowcharts that relate to downlink control information for uplink scheduling.

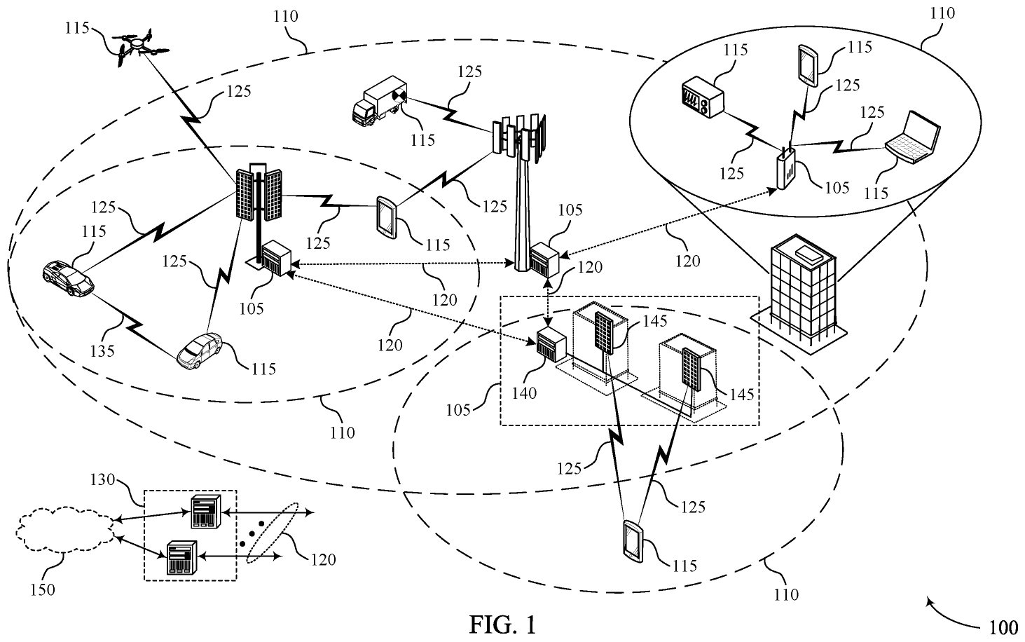

FIG. 1 illustrates an example of a wireless communications system 100 that supports downlink control information for uplink scheduling in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and ΔN_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, the base station 105 may transmit multiple, such as two, related DCI transmissions to the UE 115. As described herein, the UE 115 may receive a first DCI via a CORESET and may receive a second DCI via a shared data channel occasion. In some cases, the CORESET may be a resource allocation for carrying DCI or other transmissions carried by a physical downlink control channel (PDCCH). Further, the shared data channel occasion may refer to a location (e.g., a resource location) within a resource allocation for transmissions carried by a physical downlink shared channel (PDSCH).

The UE 115 may determine the location or configuration of the shared data channel occasion based on control signaling (e.g., RRC signaling) from the base station 105 or based on the first DCI, or both. For example, the base station 105 may transmit control signaling to the UE 115 to indicate a resource allocation for the shared data channel occasion or an indication that the UE 115 may use to determine the resource allocation for the shared data channel occasion. In some implementations, the base station 105 may additionally or alternatively provide, via the control signaling, indications of a modulation order, a DMRS configuration, or a code rate, or a combination thereof, associated with the shared data channel occasion that the UE 115 may use to receive and decode the second DCI.

The UE 115 may also determine the location of the second DCI based on the first DCI. In some examples, the first DCI may include an index of a first frequency resource at which the UE 115 may receive the second DCI. In some examples, the UE 115 may identify the first CCE occupied by the first DCI within the CORESET an aggregation level of the first DCI, or both, and determine the location of the shared data channel occasion based on the index of the first CCE occupied by the first DCI, the aggregation level of the first DCI, or both. Upon receiving and decoding the first DCI and the second DCI, the UE may determine the control information included within the first DCI and the second DCI. In some cases, one or both of the first DCI and the second DCI may include scheduling information for an uplink transmission from the UE 115 to the base station 105 and the UE 115 may transmit the uplink transmission to the base station 105 in accordance with the first DCI and the second DCI.

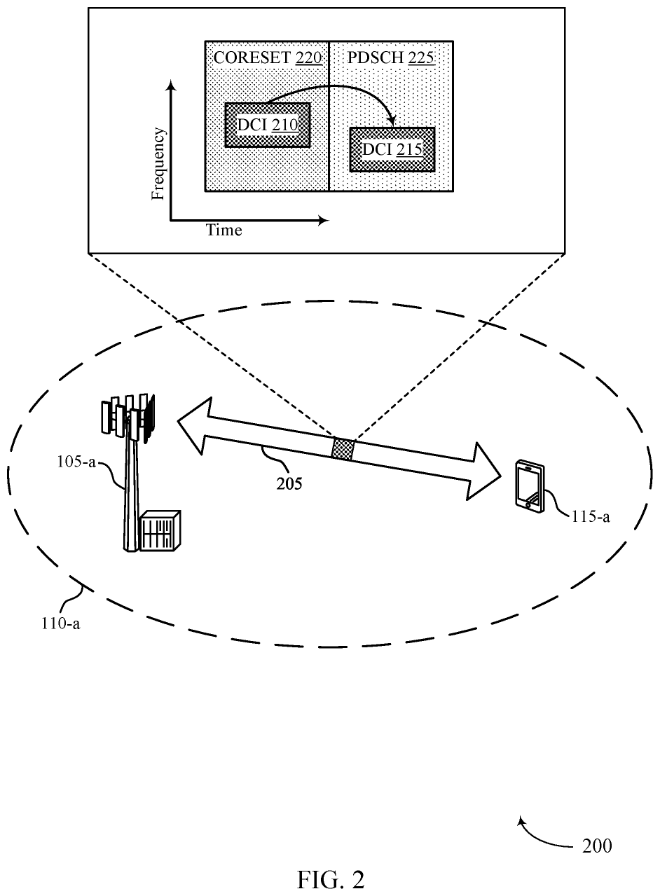

FIG. 2 illustrates an example of a wireless communications system 200 that supports DCI for uplink scheduling in accordance with aspects of the present disclosure. In some examples, the wireless communications system 200 may implement aspects of wireless communications system 100. The wireless communications system 200 may include a UE 115-a and a base station 105-a, which may be examples of corresponding devices as described herein. The base station 105-a may transmit a first DCI, such as DCI 210, to the UE 115-a via a CORESET 220 and a second DCI, such as DCI 215, to the UE 115-a via a PDSCH 225. The UE 115-a may determine the location of the DCI 215 within the PDSCH 225 based on control signaling or the DCI 210, or both, received from the base station 105-a.

The UE 115-a and the base station 105-a may communicate within a coverage area 110-a and may communicate over a communication link 205. In some cases, the base station 105-a may provide scheduling information to the UE 115-a relating to one or more uplink or downlink transmissions over the communication link 205. For example, the base station 105-a may transmit scheduling information to the UE 115-a to schedule an uplink transmission from the UE 115-a to the base station 105-a. In some aspects, the base station 105-a may transmit the uplink scheduling information to the UE 115-a in DCI 210 (e.g., an uplink DCI). In some cases, however, the uplink scheduling information or additional control information relating to the uplink scheduling information may exceed a payload size associated with the DCI 210. For example, the DCI 210 may be associated with a payload size equal to a number of bits (e.g., as defined in a specification) and the uplink scheduling information or a combination of the uplink scheduling information and the additional control information relating to the uplink scheduling information may include a greater number of bits than the number of bits that the DCI 210 may carry.

As such, the base station 105-a may determine to transmit the uplink scheduling information (e.g., for a single uplink transmission) across DCI 210 and DCI 215. The base station 105-a may transmit the DCI 210 to the UE 115-a via the CORESET 220 and may transmit the DCI 215 via the PDSCH 225, which may be a shared data channel following the CORESET 220 in time. The UE 115-a may expect to receive DCI 210 via the CORESET 220 but may be unaware of the location or size of the DCI 215 in the PDSCH 225. In some implementations of the present disclosure, the UE 115-a may determine the location and the size of the DCI 215 based on the DCI 210. For example, the UE 115-a may expect to receive the DCI 210 at an earlier point in time than the DCI 215 and may determine the location of the DCI 215 based on the decoded DCI 210 (e.g., the UE may not expect to receive the DCI 215 before the DCI 210).

In some examples, for instance, the UE 115-a may decode (e.g., blindly decode) the CORESET 220 to receive the DCI 210. For example, the UE 115-a may be pre-configured or configured (e.g., via RRC signaling) with a set of resources for the CORESET 220 and the UE 115-a may perform blind detections on the CORESET 220 to monitor a number of PDCCH occasions to receive the DCI 210. For instance, the UE 115-a may blind decode one or more search spaces in the CORESET 220 to receive the DCI 210, while DCI 215 is not blindly decoded. The UE 115-a may receive and decode the DCI 210, which may include control information associated with uplink scheduling and, in some implementations, may include information associated with the DCI 215. In some aspects, the DCI 210 may include explicit information associated with the DCI 215. For example, the UE 115-a may decode the DCI 210 and determine, based on decoding the DCI 210, the content and payload of the DCI 215. The DCI 210 may include, for instance, an indication for determining a number of bits A equal to the payload of the DCI 215. In some implementations, the number of bits A of the DCI 215, as indicated by the DCI 210, may include a number of cyclic redundancy check (CRC) bits included in the DCI 215. For example, the UE115-a may process the DCI 210 to determine the content and the payload of the DCI 215, including CRC. In other words, the base station 105-a may determine the content and the payload (e.g., payload size=A) of the DCI 215 based on the DCI 210 and may include information in the DCI 210 indicating the content and payload of the DCI 215. In some cases, the number of bits A of the DCI 215 may be approximately or less than 200 bits. In some cases, the UE 115-a is not expected to receive the DCI 215 before the DCI 210.

The DCI 215 may be associated with a number of parameters and resource allocations in addition to the payload size A. Some aspects of the DCI 215 are defined in Table 1, shown below, along with some example values.

TABLE 1
Parameters for Second DCI

| | | Example |
|---|---|---|
| Notation | Definition | Values |
| A | DCI 215 Payload | <200 |
| M_{RB, max}^{DCI2} | Number of PRBs for DCI 215 | <32 |
| | in a frequency domain | |
| | resource allocation of PDSCH | |
| | occasion | |
| M_{RB, min}^{DCI2} | Actual number of PRBs used | 2, 4 |
| | by DCI 215 in PDSCH occasion | |
| N_{SC, ctrl}^{RB} | Number of available | 12 |
| | subcarriers in a PRB | |
| N_{symb}^{DCI2} | Number of available symbols in | 4~12 |
| | a time domain resource | |
| | allocation | |
| Qₘ | MCS including Modulation order | 4 |
| | and coding rate | |
| L | Number of layers in PDSCH | 1, or 2 |

In some specific implementations, the base station 105-a may be able to transmit the DCI 210 with knowledge of the contents and payload of the DCI 215 based on the frequency allocation of the DCI 210. For example, the base station 105-b may determine that frequency allocation of the DCI 210 includes a number of subbands (e.g., 10 subbands) and that the DCI 215 may include a subband precoder indication for each of the number of subbands, where each subband precoder indication may be associated with a number of bits (e.g., 4 bits). Accordingly, the base station 105-a may know the number of subband precoder indications and the number of bits that each subband precoder indication uses and may determine the size of the DCI 215 accordingly (e.g., 40 bits). As such, the base station 105-a may transmit an indication of the content and payload of the DCI 215 in the DCI 210. In some implementations of the present disclosure, the UE 115-a may receive the DCI 210 and determine the content and payload of the DCI 215 based on the DCI 210 (e.g., based on the indication in the DCI 210). In other words, the DCI 215 may be dependent on the DCI 210.

In some other aspects, the UE 115-a may determine the size of the DCI 215 implicitly (e.g., without an explicit indication in the DCI 210). For example, the UE 115-a may be configured with a rule that the UE 115-a may use to determine the size of the DCI 215 based on one or more characteristics of the DCI 210. In some examples, the UE 115-a may determine the size (e.g., the payload or the number of bits) of the DCI 215 based on the frequency resources occupied by the DCI 210. For instance, the UE 115-a may perform a similar computation as described above in the context of the base station 105-a. That is, the UE 115-a may determine a size of the DCI 215 that depends on a frequency allocation indicated by the DCI 210 for the uplink transmission, such that the DCI 215 is of sufficient size to include a number of subband precoder indications corresponding to the size of the frequency allocation for the uplink transmission indicated in the DCI 210. For example, the UE 115-a may determine that the DCI 215 includes a subband precoder indication for each subband of the frequency allocation of the uplink transmission indicated in the DCI 210 and may know how many bits each subband precoder indication may use. Accordingly, the UE 115-a may determine the number of subbands within the frequency allocation of the DCI 210 and multiply the number of subbands by the number of bits used by each subband precoder indication to determine the size of the uplink transmission indicated in DCI 215. In some examples, the UE 115-a may determine to perform such a precoder-based computation to determine the size of the DCI 215 based on identifying an indication within the DCI 210 that subband precoding is enabled and by identifying that the DCI 210 is absent of such precoding information. As such, the UE 115-a may assume such precoding information is included within the DCI 215.

In either implementation, the UE 115-a may determine the payload size of the DCI 215 based on the DCI 210. The UE 115-a, however, may still be unaware of where the UE 115-a may receive the DCI 215. Accordingly, in some implementations of the present disclosure, the UE 115-a may receive control signaling (e.g., RRC) signaling from the base station that may configure a shared data channel occasion within the PDSCH 225 (e.g., a PDSCH occasion) in which the UE 115-a may receive the DCI 215.

In some examples, the base station 105-a, via the control signaling, may indicate the resource allocation of the occasion in the PDSCH 225. The resource allocation may include a time domain resource allocation and a frequency domain frequency allocation for the PDSCH occasion. For example, the base station 105-a may indicate the frequency allocation by one or more fields or values indicating the first frequency resource that the PDSCH occasion may occupy and the total number of frequency resources from the first frequency resource that the PDSCH occasion may occupy. For instance, the UE 115-a may receive an indication in the control signaling of the first resource block (RB) or physical RB (PRB) that the PDSCH occasion may occupy and the total number of PRBs that the PDSCH occasion may occupy. As such, the UE 115-a may determine the PRBs that the PDSCH occasion may occupy (e.g., start_PRB+nrofPRBs). In some cases, the UE 115-a may determine the first PRB based on an index value of the PRB associated with start_PRB.

Similarly, the UE 115-a may receive an indication in the control signaling of the first time resource that the PDSCH occasion may occupy and the total number of time resources that the PDSCH occasion may occupy. For instance, the UE 115-a may receive an indication of a first orthogonal frequency division multiplexing (OFDM) symbol that the PDSCH occasion may occupy and the total number of OFDM symbols that the PDSCH occasion may occupy. As such, the UE 115-a may determine the OFDM symbols that the PDSCH occasion may occupy (e.g., start_sym+nrofSym). In some cases, the UE 115-a may determine the first OFDM symbol based on an index value of the first OFDM symbol associated with start_sym (e.g., an index value between 0 and 13 indicating a symbol of a 14 symbol-length slot).

Additionally or alternatively, the UE 115-a may receive an indication of an offset (e.g., a time domain offset) that the UE 115-a may use to determine the location of the occasion in the PDSCH 225 in which the UE 115-a may receive the DCI 215. In some cases, the offset may be referred to as K0 and may refer to a number of slots relative to the slot in which the UE 115-a receives the DCI 210. For example, the UE 115-a may receive the indication of the offset from the base station 105-a and may accordingly determine that the UE 115-a may receive the DCI 215 in an occasion in the PDSCH 225 K0 slots after the slot or occasion in which the UE 115-a receives the DCI 210. The UE 115-a may receive the indication of K0 via RRC signaling (e.g., the base station 105-a may configure K0 dynamically) or within the first DCI 210. Alternatively or additionally, K0 may be fixed to pre-configured value. For example, K0 may be fixed to zero and, as such, the UE 115-a may receive the PDSCH occasion including the DCI 215 within the same slot as the UE 115-a receives the DCI 210.

In some implementations, the base station 105-a may transmit an indication of the modulation order of the PDSCH 225 occasion in which the DCI 215 may be received. For example, the base station 105-a may indicate the modulation order that the base station 105-a may use to transmit the DCI 215 and, likewise, the modulation order that the UE 115-a may use to receive and decode the DCI 215 from the PDSCH occasion. The base station 105-a may indicate the modulation order via a modulation parameter Qₘ, as defined in Table 1. The base station 105-a may use a variety of values for Qₘ (e.g., 4, 8, 16, 17, etc.) and the modulation order may be fixed or configurable (e.g., dynamically configurable, such as by RRC configuration). In some cases, the modulation order may be related to a modulation and coding scheme (MCS), such as defined by a specification. As such, the base station 105-a may additionally or alternatively transmit an indication of the MCS that the base station 105a may use to transmit the DCI 215 and, likewise, the MCS that the UE 115-a may use to receive and decode the PDSCH occasion for the DCI 215. In some cases, MCS=28,29,30,31 that indicates modulation order without coding rate may be used.

The base station 105-a may provide an indication of a DMRS configuration associated with the PDSCH occasion in which the UE 115-a may receive the DCI 215. For example, the DMRS configuration may include the DMRS type (e.g., type I or type II), the maximum DMRS length (e.g., 1 or 2), and additional DMRS positions that are used in the PDSCH occasion. The base station 105-a may additionally or alternatively provide a number of other configurable parameters or indications to the UE 115-a. For example, the base station 105-a may configure (e.g., RRC configure) a rate-matching indicator, a virtual resource block (VRB) to PRB mapping, a PRB bundling size indicator, a zero-power (ZP) channel state information (CSI) reference signal (CSI-RS) trigger, a number of antenna ports, a transmission configuration indication, a DMRS sequence initialization, a maximum coding rate, a maximum payload, or a combination thereof, among other examples. The UE 115-a may use one or any combination of the configured parameters to decode the PDSCH occasion to obtain the DCI 215. In some cases, rate-matching indicator may indicate how the PDSCH 225 is rate-matched, such as how the PDSCH 225 is rate-matched around reserved resources. In some cases, the base station 105-a may refrain from configuring HARQ ID, a corresponding physical uplink control channel (PUCCH), or a code block group (CBG) associated with the PDSCH 225.

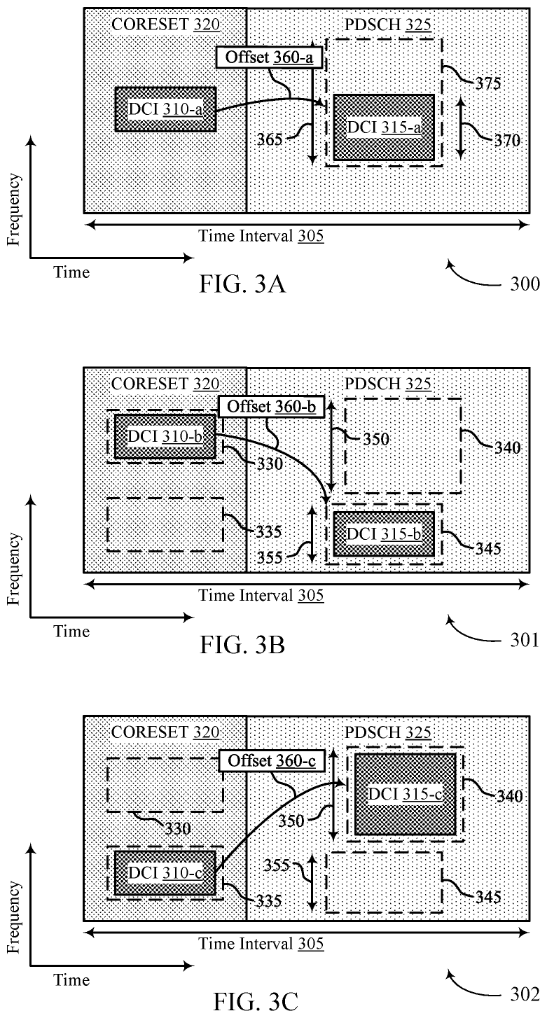

As such, the occasion in the PDSCH 225 for the DCI 215 may be associated with (e.g., defined by) a set of frequency resources, a set of time resources, and may be associated with a DMRS configuration among other configurations. In some examples, the resource allocation for the PDSCH occasion may be different than the actual resources occupied by the DCI 215. For example, the DCI 215 may occupy a subset of the resources of the resource allocation and the UE 115-a may determine which resources the DCI 215 may actually occupy based on a pre-configured rule, an indication in the first DCI 210, or control signaling (e.g., RRC signaling), as described in more detail with reference to FIG. 3. Additionally or alternatively, the base station 105-a may configure multiple (e.g., two) PDSCH occasions for the DCI 215 and the UE 115-a may determine which PDSCH occasion includes the DCI 215 based on the DCI 210, as described in more detail with reference to FIG. 3. Accordingly, the UE 115-a may be aware of the location at which the UE 115-a may receive the DCI 215 and, as such, the UE 115-a may receive the DCI 215 without blind detection.

The UE 115-a, in some implementations, may receive and decode the DCI 215. In some examples, the UE 115-a may decode the DCI 215 based on performing a polar decoding technique or a low density parity check (LDPC) decoding technique. In some cases, the decoding technique used by the UE 115-a may be based on the encoding technique used by the base station 105-a. For example, if the base station 105-a performs a polar encoding technique when encoding the DCI 215, the UE 115-a may likewise decode the DCI 215 by performing the polar decoding technique. Similarly, if the base station 105-a performs an LDPC encoding technique to encode the DCI 215, the UE 115-a may likewise decode the DCI 215 by performing the LDPC decoding technique.

In some examples, the UE 115-a may decode the DCI 315 by performing polar decoding. As such, the UE 115-a may be able to implement a low code rate and decode smaller packets, which may result in better decoding performance and efficiency. Moreover, implementing polar decoding techniques for the DCI 215 may enable the UE 115-a to similarly decode the DCI 210 and the DCI 215 (e.g., the UE 115-a may perform polar decoding to decode the DCI 210). This may be associated with a greater likelihood of successful decoding, because the UE 115-a has already successfully polar decoded the DCI 210 by the time the UE 115-a is decoding the DCI 215. Additionally, polar decoding the DCI 215 may enable the UE 115-a to perform parallel decoding. For example, the UE 115-a may use one or more processing units or pipelines associated with a polar decoder to polar decode the DCI 215 while using other processing units or pipelines associated with an LDPC decoder to decode the PDSCH 225.

Alternatively, the UE 115-a may perform LDPC decoding to decode the DCI 215. As such, the UE 115-a may maintain a consistent decoding technique throughout decoding the PDSCH 225 (e.g., PDSCH 225, or data carried by PDSCH 225, may be decoded using LDPC decoding). In some implementations, the UE 115-a may allocate the OFDM symbols occupied by the DCI 215 to the symbols in the LDPC decoding pipeline according to a low-latency criterion to avoid decoding latency.

FIGS. 3A, 3B, and 3C illustrate example DCI configurations 300, 301, and 302 that support DCI for uplink scheduling in accordance with aspects of the present disclosure. In some examples, the DCI configurations 300, 301, and 302 may implement aspects of wireless communications system 100 and wireless communications system 200. The DCI configurations 300, 301, and 302 may illustrate a two-part DCI including a DCI 310 and a DCI 315 that are transmitted from a base station 105 to a UE 115, which may be examples of corresponding devices as described herein. The UE 115 may receive the DCI 310 in a CORESET 320 and may receive the DCI 315 in a configured occasion in PDSCH 325, such as PDSCH occasion 340, PDSCH occasion 345, or PDSCH occasion 375. The UE 115 may receive the DCI 310 and the DCI 315 within a time interval 305, which may be an example of a transmission time interval, a slot, or a number of slots.

As described herein, the UE 115 may determine the location of the DCI 315 in a configured shared data channel occasion based on the DCI 310 and control signaling from the base station 105. For example, the UE 115 may determine a resource allocation, such as a resource allocation that may define a PDSCH occasion, based on indications received in the DCI 310 or by control signaling from the base station 105. In some examples, however, the DCI 315 may occupy a subset, or up to all, of the resources of the PDSCH occasion. In such examples, the UE 115-a may determine the actual resource allocation of the DCI 315 within the PDSCH occasion based on one or more indications included in the DCI 310, or one or more indications from the base station 105 via control signaling, or both.

In FIG. 3A, the UE 115 may determine that the base station 105 may transmit the DCI 315-a in the PDSCH occasion 375 (e.g., a configured PDSCH occasion). The PDSCH occasion 375 may be associated with a time-domain offset 360-a relative to a time when the UE 115 receives DCI 310-a and the PDSCH occasion 375 may be associated with a number of PRBs 365. In some examples, the DCI 315-a may use a number of PRBs 370. In some cases, the number of PRBs 370 that the DCI 315-a uses may be based on the size of the DCI 315-a (e.g., the payload or the number of bits carried by the DCI 315-a). The UE 115-a may determine the PRBs 370 that the DCI 315-a uses starting from the first PRB of the number of PRBs 365 of the PDSCH occasion 375 (e.g., as indicated by start_PRB). In some aspects, the rate-matching may be based on the rate-matching indicator in control signaling or higher layer configuration starting from the first PRB of the number of PRBs 370 that the DCI 315-a uses.

In some implementations of the present disclosure, the UE 115 may determine (or assume) that the DCI 315-a uses all of the PRBs 365 of the configured PDSCH occasion 375, which may be referred to as M_{RB,max}^{DCI2}, as further defined in Table 1. In some cases, M_{RB,max}^{DCI2} may be less than or equal to 32 PRBs of the PDSCH 325. In some examples, the UE 115 may determine that the DCI 315-a uses the number of PRBs 365 of the configured PDSCH occasion 375 based on control signaling from the base station 105 (e.g., based on an RRC configuration from the base station 105). By monitoring and attempting to decode all of the PRBs 365 of the PDSCH occasion 375, the UE 115 may increase reliability based on decreasing the likelihood of missing a number of the PRBs 370 occupied by the DCI 315-a. Moreover, determining that the DCI 315-a uses all of the PRBs 365 of the configured PDSCH occasion 375 may be simple to implement and may use less control signaling (e.g., the UE 115 may be configured to determine that the DCI 315-a uses all of the PRBs 365 of the PDSCH occasion 375 once).

In some other implementations, the UE 115 may determine the number of PRBs 370 that the DCI 315-a uses as a subset of the number of PRBs 365 of the PDSCH occasion 375. In some aspects, the number of PRBs 370 of the PRBs 365 that the DCI 315-a uses may be referred to as M_{RB,min}^{DCI2} (e.g., when the number of PRBs 370 is less than the number of PRBs 365), as further defined in Table 1. In some cases, R_{RB,min}^{DCI2} may be 2 or 4 PRBs. In some examples, the UE 115-a may determine the number of PRBs 370 that the DCI 315-a uses based on determining a fraction of the PRBs 365. In such examples, the UE 115 may determine the number of PRBs 370 based on an explicit indication in the DCI 310-a.

For example, the DCI 310-a may include an index having a number of bits (e.g., two bits) that indicate the number of PRBs 370 (e.g., the fraction of the number of PRBs 365) of a configured PDSCH occasion in which the DCI 315-a is transmitted. For instance, the DCI 310-a may indicate that the DCI 315-a uses all of PRBs 365 (e.g., M_{RB,min}^{DCI2}=M_{RB,max}^{DCI2}) of a configured PDSCH occasion if the DCI 310a includes a first bit value, such as 00. In other examples, the DCI 310-a may indicate that the DCI 315-a uses half of the PRBs 365 (e.g., M_{RB,min}^{DCI2}=M_{RB,max}^{DCI}/2) of a configured PDSCH occasion if the DCI 310-a includes a second bit value, such as 01, that the DCI 315-a uses a quarter of the PRBs 365 (e.g., M_{RB,min}^{DCI2}=M_{RB,max}^{DCI}/4) of a configured PDSCH occasion if the DCI 310-a includes a third bit value, such as 10, and that the DCI 315-a uses an eighth of the PRBs 365 (e.g., M_{RB,min}^{DCI2}=M_{RB,max}^{DCI}/8) of a configured PDSCH occasion if the DCI 310-a includes a fourth bit value, such as 11. Although this example is described in the context of two bits, the DCI 310-a may use a different number of bits, such as 1, 3, or 4 bits, to indicate the number of PRBs 370 that the DCI 315-a uses without exceeding the scope of the present disclosure.

Additionally or alternatively, the UE 115 may determine the number of PRBs 370 that the DCI 315-a uses based on a configured code rate (e.g., a maximum coding rate) associated with the PDSCH occasion 375. For example, the base station 105 may configure (e.g., RRC configure) a code rate, such as maxcoderate r, for the PDSCH occasion 375 and the UE 115 may derive the number of PRBs 370 with the configured PDSCH occasion in which the DCI 315-a is transmitted based on the code rate r. In some examples, the UE 115 may use the code rate r to calculate the number of PRBs 370 of a configured PDSCH occasion in which the DCI 315-a is transmitted (e.g., M_{RB,min}^{DCI2}), which may accommodate the size of the DCI 315-a (i.e., the payload size A). Equations 1 and 2, shown below, illustrate an example computation to determine the number of PRBs 370 that the DCI 315-a uses based on the code rate r:

A≤L*(M_{RB,min}^{DCI2}·N_{SC,ctrl}^{RB}·N_{symb}^{DCI2})·Qₘ·r (1)

and if M_{RB,min}^{DCI}>1:

A>L*((M_{RB,min}^{DCI2}−1)·N_{SC,ctrl}^{RB}·N_{symb}^{DCI2})·Qₘ·r (2)

As illustrated in Equations 1 and 2, L is the number of layers in PDSCH 325, N_{SC,ctrl}^{RB} is the number of available subcarriers in a PRB, N_{symb}^{DCI2} is the number of available symbols in a time domain resource allocation associated with PDSCH occasion 375, and Qₘ is the modulation order, as described in more detail with reference to FIG. 2. L, Qₘ, N_{symb}^{DCI2}, N_{sc,ctrl}^{RB}, M_{RB,min}^{DCI2}, A are further defined by Table 1, which may additionally include some example values for each term.

In some implementations, DCI 315-a may be communicated within a subset of the total number of PRBs 370 of a configured PDSCH occasion to more efficiently use the PRB resources. Further, the reliability of this approach may be based on the code rate or the number of PRBs 370 that the DCI 315-a uses. In some cases, the rate-matching may be based on the rate-matching indicator in control signaling or higher layer configuration.

In some implementations, the UE 115 may determine that there are multiple PDSCH occasions in which the DCI 315 may be received, and the specific PDSCH occasion being used for DCI 315 may be determined by the DCI 310. For example, as illustrated in FIGS. 3B and 3C, the UE 115 may receive control signaling from the base station that configures resource allocations for receiving the DCI 315 at both PDSCH occasion 340 and PDSCH occasion 345. In some cases, the base station 105 may configure the UE 115 with multiple PDSCH occasions to achieve higher system flexibility based on such flexible resource allocations. In some examples, the UE 115 may determine in which of the PDSCH occasion 340 or the PDSCH occasion 345 the base station 105 may transmit the DCI 315 based on the DCI 310.

In FIG. 3B, the UE 115 may receive DCI 310-b in a PDCCH occasion 330 (e.g., a PDCCH search space or PDCCH monitoring occasion) and determine whether the UE 115 may receive the DCI 315-b in PDSCH occasion 340 or in PDSCH occasion 345. In some examples, the UE 115 may determine whether the UE 115 may receive DCI 315-b in PDSCH occasion 340 or in PDSCH occasion 345 based on an implicit rule configured at the UE 115. For example, the UE 115 may associate an aggregation level or a CCE starting index of the DCI 310-b with either the PDSCH occasion 340 or the PDSCH occasion 345. For instance, the UE 115 may identify an aggregation level of the DCI 310-b and determine that the UE 115 may receive the DCI 315-b in PDSCH occasion 345 based on the aggregation level of the DCI 310-b. Additionally or alternatively, the UE 115 may receive the DCI 310-b in the PDCCH occasion 330 that is associated with a first CCE starting index (e.g., an index value of the lowest frequency CCE that the DCI 310-c uses) and the UE 115 may accordingly determine that the UE 115 may receive the DCI 315-b in the PDSCH occasion 340 or the PDSCH occasion 345 based on the first CCE starting index. For instance, the UE 115 may determine that PDCCH occasion 330 (e.g., the resources the DCI 310-b uses) is associated with a CCE starting index of 1 and the UE may determine that the UE 115 may receive the DCI 315-b in PDSCH occasion 345 based on the CCE starting index of 1 of the DCI 310-b.

In some other examples, the UE 115 may determine whether the UE 115 may receive the DCI 315-b in the PDSCH occasion 340 or the PDSCH occasion 345 based on an explicit indication in the DCI 310-b (e.g., based on a number of bits in DCI 310-b). For example, the DCI 310-b may include a PDSCH occasion indicator value or an offset 360-b, among other examples of values or fields within a DCI that may distinguish between two or more PDSCH occasions that each may vary from one another in time, frequency, or both. In some aspects, the UE 115 may use the offset 360-b (e.g., a time domain offset, such as a K0 value) to distinguish between PDSCH occasion 340 and PDSCH occasion 345. For instance, PDSCH occasion 340 and PDSCH occasion 345 may be associated with different time domain resources and the UE 115 may implement the offset 360-b to determine that the UE 115 may receive the DCI 315-b in PDSCH occasion 345.

In FIG. 3C, the UE 115 may receive DCI 310-c in a PDCCH occasion 335 and determine whether the UE 115 may receive the DCI 315-c in the PDSCH occasion 340 or in the PDSCH occasion 345. In some examples, the UE 115 may determine whether the UE 115 may receive the DCI 315-c in the PDSCH occasion 340 or in the PDSCH occasion 345 based on an implicit rule configured at the UE 115. For example, the UE 115 may associate an aggregation level or a CCE starting index of the DCI 310-c with either the PDSCH occasion 340 or the PDSCH occasion 345. For instance, the UE 115 may identify an aggregation level of the DCI 310-c and determine that the UE 115 may receive the DCI 315-c in PDSCH occasion 340 based on the aggregation level of the DCI 310-c. Additionally or alternatively, the UE 115 may determine that the DCI 310-c was received in the PDCCH occasion 335 that is associated with a second CCE starting index of 0 and the UE 115 may accordingly determine that the UE 115 may receive the DCI 315-c in PDSCH occasion 340 based on the second CCE starting index of 0 of the DCI 310-c.

In some other examples, the UE 115 may determine whether the UE 115 may receive the DCI 315-c in the PDSCH occasion 340 or in the PDSCH occasion 345 based on an explicit indication in the DCI 310-c (e.g., based on a number of bits in DCI 310-c). For example, the DCI 310-c may include a PDSCH occasion indicator value or an offset 360-c, among other examples of values or fields within a DCI that may distinguish between two resource occasions. In some aspects, the UE 115 may use the offset 360-c (e.g., a time domain offset, such as a K0 value) to distinguish between the PDSCH occasion 340 and the PDSCH occasion 345. For instance, the PDSCH occasion 340 and the PDSCH occasion 345 may be associated with different time domain resources and the UE 115 may implement the offset 360-c to determine that the UE 115 may receive the DCI 315-c in the PDSCH occasion 340.

In some further examples, the UE 115 may determine whether the UE 115 may receive the DCI 315-c in the PDSCH occasion 340 or the PDSCH occasion 345 based on the size of the DCI 315-c. For example, the UE 115 may determine that the PDSCH occasion 340 includes a number of PRBs 350 and that the PDSCH occasion 345 includes a number of PRBs 355. The UE 115 may determine, either by calculating or by identifying an indication, as described in more detail with reference to FIGS. 2 and 3A, the number of PRBs that the DCI 315-c may use. The UE 115 may compare the number of PRBs that the DCI 315-c may use to the number of PRBs 350 and 355 and the UE 115 may expect to receive the DCI 315-c in the PDSCH occasion that is large enough to carry the DCI 315-c. For example, the UE 115 may receive the DCI 315-c in a PDSCH occasion associated with a maximum payload greater than the payload of the DCI 315-c (e.g., maximumpayload of PDSCH Occasion>A). In some specific examples, the UE 115 may determine that the payload of the DCI 315-c is greater than the maximum payload associated with the number of PRBs 355 of the PDSCH occasion 345 and less than or equal to the maximum payload associated with the number of PRBs 350 of the PDSCH occasion 340. Accordingly, the UE 115 may expect to receive the DCI 315-c in the PDSCH occasion 340.

Upon reception of the DCI 315, the UE 115 may decode the DCI 315 by performing polar decoding or LDPC decoding, as described in more detail with reference to FIG. 2. In some examples, the control information in the DCI 315 may be related to or correspond to the control information in the DCI 310 and the UE 115 may likewise consider the control information received in the DCI 310 and the DCI 315 as related. In some examples, the DCI 310 and the DCI 315 may include control information associated with scheduling an uplink transmission from the UE 115 to the base station 105 and the UE 115 may transmit the uplink transmission to the base station 105 in accordance with the DCI 310 and the DCI 315.

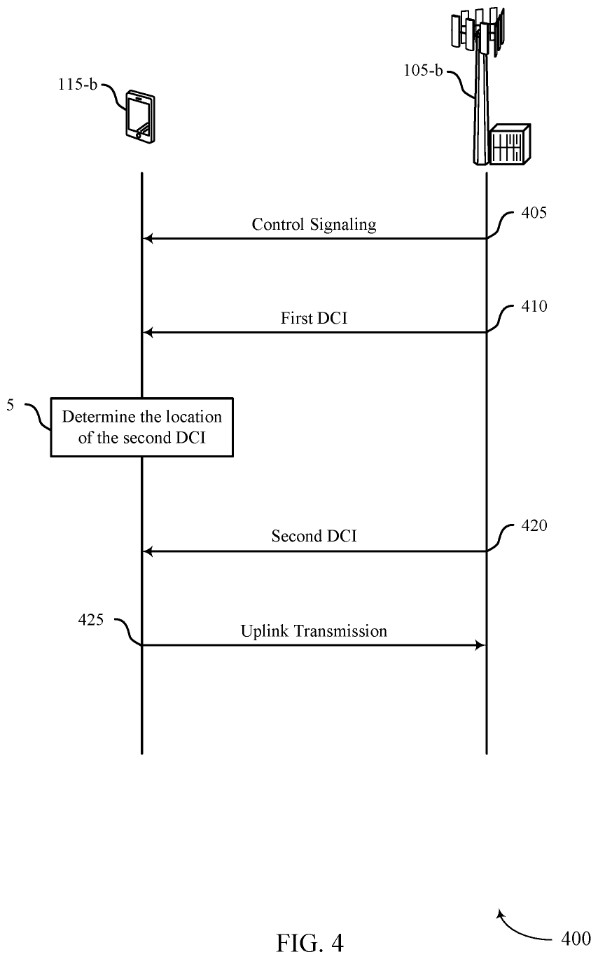

FIG. 4 illustrates an example of a process flow 400 that supports downlink control information for uplink scheduling in accordance with aspects of the present disclosure. In some examples, the process flow 400 may implement aspects of wireless communication system 100. The process flow 400 may illustrate communication between a UE 115-b and a base station 105-b, which may be examples of corresponding devices as described herein. As described herein, the UE 115-b may receive a first DCI in a CORESET and a second DCI in a configured PDSCH occasion. Alternative examples of the following may be implemented, where some steps are performed in a different order than described or are not performed at all. In some cases, steps may include additional features not mentioned below, or further steps may be added.

At 405, the base station 105-b may transmit control signaling to configure the UE 115-b with a shared data channel occasion. In some examples, the shared data channel occasion may be referred to as a PDSCH occasion. In some implementations, the control signaling may indicate a time domain resource allocation or a frequency domain resource allocation, or both, for the shared data channel occasion. In some aspects, the time domain resource allocation may indicate one or more symbol periods, such as OFDM symbols, and the frequency domain resource allocation may indicate one or more RBs or PRBs.

Additionally or alternatively, the control signaling may indicate an offset for the shared data channel occasion relative to location of the first DCI in the CORESET. In some examples, the offset may be a time domain offset that indicates a number of slots between the first DCI and the second DCI, such as a K0 value. In some aspects, the control signaling may indicate a modulation order, such as Qₘ, that is configured for the shared data channel occasion. In some examples, the UE 115-b may receive and decode the second DCI based on the modulation order. The control signaling may additionally, in some aspects, include a DMRS configuration that is configured for the shared data channel occasion.

In some implementations, the control signaling may further indicate that the second DCI may be communicated (e.g., received by the UE 115-b) with at least a subset or a portion of the number of RBs or PRBs allocated for the shared data channel occasion. In some examples, the control signaling may indicate that the second DCI may be communicated (e.g., received by the UE 115-b) using all of the PRBs allocated for the shared data channel occasion. For example, the UE 115-b may receive the second DCI using M_{RB,max}^{DCI2}. In some aspects, the control signaling may indicate a code rate (e.g., a maximum code rate r) configured for the shared data channel occasion. Additionally, the control signaling may configure the UE 115-b with a first shared data channel occasion and a second shared data channel occasion.

At 410, the base station 105-b may transmit the first DCI to the UE 115-b via a CORESET. In some examples, the UE 115-b may perform blind decoding of one or more search spaces in the CORESET to decode the first DCI. In some cases, the UE 115-b may decode the first DCI using polar decoding techniques. In some aspects, the first DCI may include scheduling information associated with an uplink transmission.

In some implementations, the first DCI may include an index that indicates a subset of RBs or PRBs of a set of RBs or PRBs in which the second DCI may be communicated (e.g., received at the UE 115-b). Additionally, the first DCI may be associated with an aggregation level and a CCE starting index (e.g., the index of the first CCE occupied by the first DCI). In some examples, the first DCI may include an index (e.g., a PDSCH occasion indicator) or an offset (e.g., a K0 value) associated with the location of the second DCI. Further, the first DCI may occupy a set of subbands and may include an indication of subband precoding that the UE 115-b may use to determine the size of the second DCI.

At 415, the UE 115-b may determine the location of the second DCI. The UE 115-b may determine the location of the second DCI within the shared data channel occasion, (e.g., the PDSCH occasion). As described herein, the UE 115-b may determine the location of the second DCI based on the control signaling received from the base station 105-b at 405 or based on one or more explicit or implicit indications in the first DCI received from the base station 105-b at 410, or both.

At 420, the base station 105-b may transmit the second DCI via the shared data channel occasion. In some aspects, the second DCI may have a payload size that is dependent on the first DCI (e.g., dependent on the number of subbands that the first DCI uses). The UE 115-b may receive the second DCI based on the offset in the control signaling or in the first DCI, the modulation order, the DMRS configuration, the code rate, the index in the first DCI, the aggregation level of the first DCI, the CCE starting index of the first DCI, the payload size of the second DCI, or any combination thereof. The UE 115-b may decode the second DCI based on performing polar decoding or LDPC decoding.

At 425, the UE 115-b may transmit an uplink transmission in accordance with the first DCI and the second DCI. In some examples, the first DCI and the second DCI may include related control information and the UE 115-b may use the control information from both the first DCI and the second DCI to determine the scheduling information associated with the uplink transmission. In some other examples, the first DCI may include the scheduling information and the second DCI may include the subband precoder indications and a number of precoders associated with the control information in the first DCI.

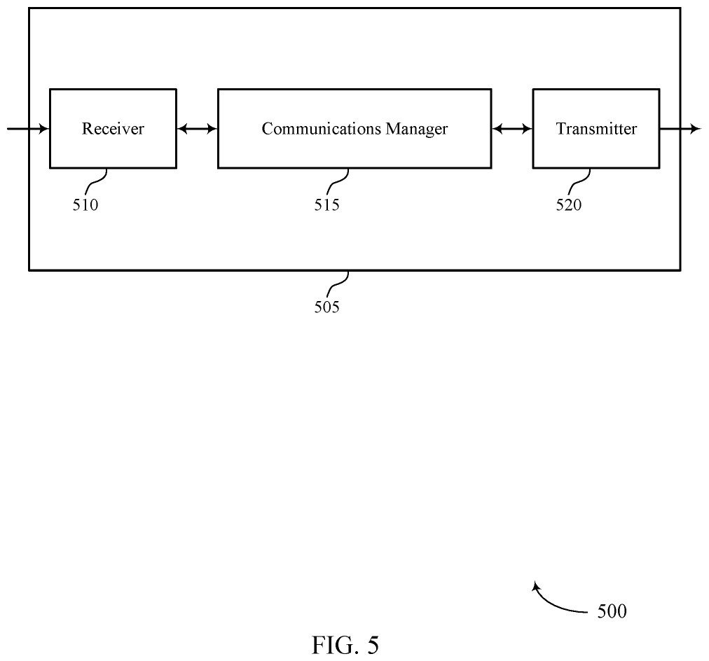

FIG. 5 shows a block diagram 500 of a device 505 that supports DCI for uplink scheduling in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

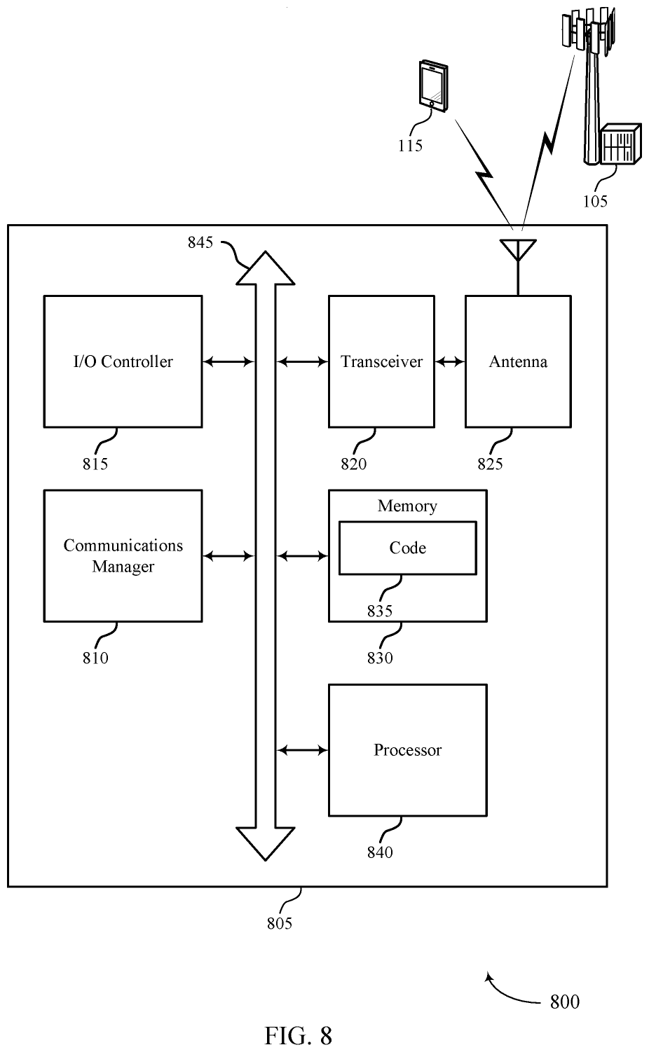

The receiver 510 may receive information such as packets, user data, or control information associated with various information channels (e.g., control channels, data channels, and information related to DCI for uplink scheduling, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive control signaling configuring the user equipment with a shared data channel occasion, receive first DCI via a CORESET, receive second DCI via the shared data channel occasion, and transmit an uplink transmission in accordance with the first DCI and the second DCI. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

In some examples, the communications manager 515 may be implemented as an integrated circuit or chipset for a mobile device modem, and the receiver 510 and transmitter 520 may be implemented as analog components (e.g., amplifiers, filters, antennas) coupled with the mobile device modem to enable wireless transmission and reception over one or more bands.

The communications manager 515 as described herein may be implemented to realize one or more potential advantages. One implementation may allow the device 505 to receive greater amounts of control information from a base station based in part on being able to receive multiple related DCIs, where the device 505 may receive a first DCI via a CORESET and may receive a second DCI via a shared data channel occasion, such as a PDSCH occasion. Based on receiving more control information, the device 505 may support increased communication capacity and may be increase data throughput. Further, based on receiving the second DCI via the shared data channel occasion, the device 505 may receive greater amounts of control information without delaying data transmissions over the shared data channel.

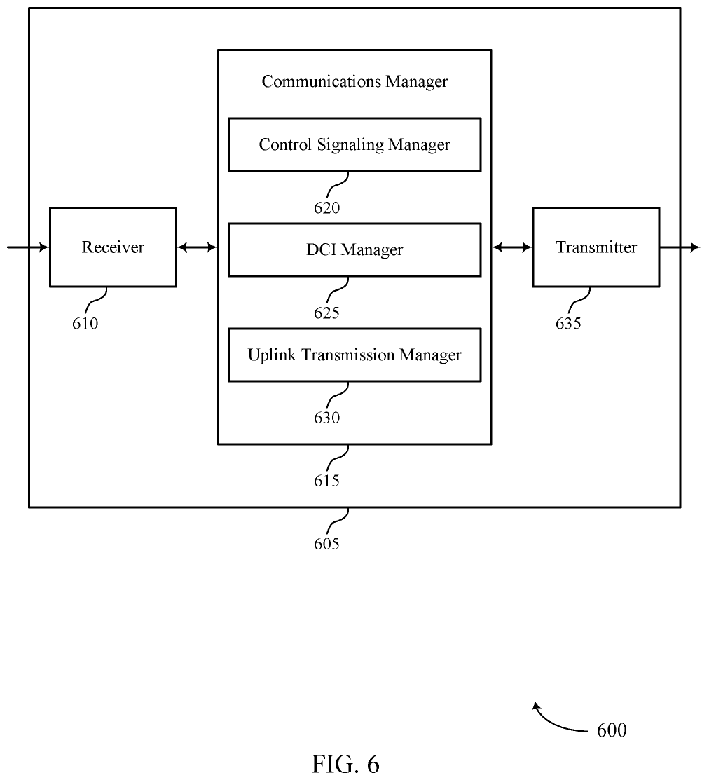

FIG. 6 shows a block diagram 600 of a device 605 that supports DCI for uplink scheduling in accordance with aspects of the present disclosure. The device 605 may be an example of aspects of a device 505, or a UE 115 as described herein. The device 605 may include a receiver 610, a communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to DCI for uplink scheduling, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a control signaling manager 620, a DCI manager 625, and an uplink transmission manager 630. The communications manager 615 may be an example of aspects of the communications manager 810 described herein.

The control signaling manager 620 may receive control signaling configuring the user equipment with a shared data channel occasion. The DCI manager 625 may receive first DCI via a CORESET and receive second DCI via the shared data channel occasion. The uplink transmission manager 630 may transmit an uplink transmission in accordance with the first DCI and the second DCI.

The transmitter 635 may transmit signals generated by other components of the device 605. In some examples, the transmitter 635 may be collocated with a receiver 610 in a transceiver module. For example, the transmitter 635 may be an example of aspects of the transceiver 820 described with reference to FIG. 8. The transmitter 635 may utilize a single antenna or a set of antennas.

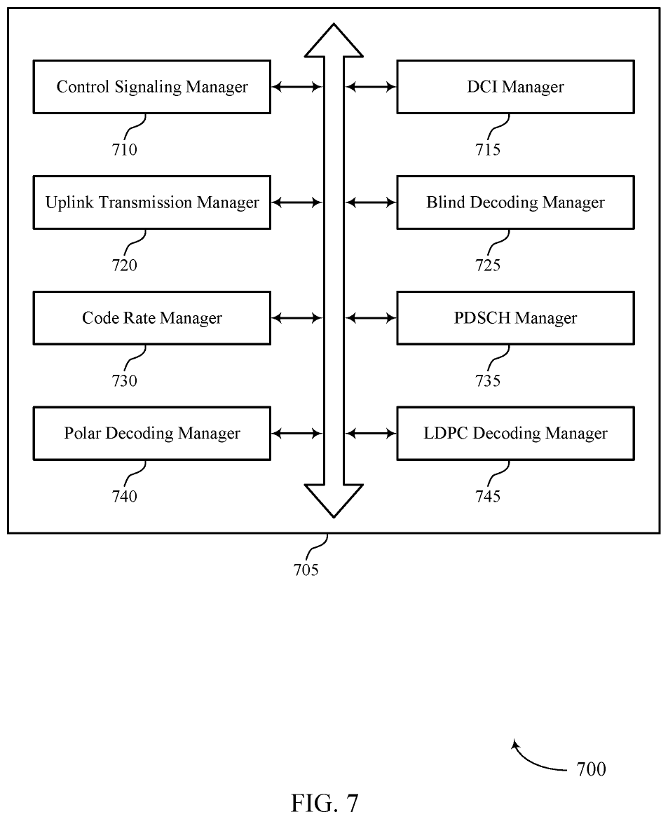

FIG. 7 shows a block diagram 700 of a communications manager 705 that supports DCI for uplink scheduling in accordance with aspects of the present disclosure. The communications manager 705 may be an example of aspects of a communications manager 515, a communications manager 615, or a communications manager 810 described herein. The communications manager 705 may include a control signaling manager 710, a DCI manager 715, an uplink transmission manager 720, a blind decoding manager 725, a code rate manager 730, a PDSCH manager 735, a polar decoding manager 740, and a LDPC decoding manager 745. Each of these modules may communicate, directly or indirectly, with one another (e.g., via one or more buses).

The control signaling manager 710 may receive control signaling configuring the user equipment with a shared data channel occasion.

In some examples, the control signaling manager 710 may receive the control signaling that indicates a time domain resource allocation, a frequency domain resource allocation, or both, for the shared data channel occasion. In some examples, the control signaling manager 710 may receive the control signaling that indicates the time domain resource allocation that indicates one or more symbol periods, the frequency domain resource allocation that indicates one or more RBs, or both, for the shared data channel occasion. In some examples, the control signaling manager 710 may receive the control signaling that indicates an offset for the shared data channel occasion relative to a location of the first DCI in the CORESET, where the second DCI is received based on the offset.

In some examples, the control signaling manager 710 may receive the control signaling that indicates a modulation order configured for the shared data channel occasion, where the second DCI is received based on the modulation order. In some examples, the control signaling manager 710 may receive the control signaling that indicates a demodulation reference signal configuration configured for the shared data channel occasion, where the second DCI is received based on the demodulation reference signal configuration. In some examples, the control signaling manager 710 may receive the control signaling indicating that the second DCI is communicated within at least a subset of a set of RBs allocated for the shared data channel occasion.

In some examples, the control signaling manager 710 may receive the control signaling indicating that the second DCI is communicated within all of the set of RBs allocated for the shared data channel occasion. In some examples, the control signaling manager 710 may receive the control signaling that indicates a code rate configured for the shared data channel occasion. In some examples, the control signaling manager 710 may receive the control signaling configuring the user equipment with a first shared data channel occasion and a second shared data channel occasion within a shared data channel, where the second DCI is received within one of the first shared data channel occasion or the second shared data channel occasion based on the first DCI.

The DCI manager 715 may receive first DCI via a CORESET. In some examples, the DCI manager 715 may receive second DCI via the shared data channel occasion. In some examples, the DCI manager 715 may receive the second DCI that has a payload size that is dependent on the first DCI. In some examples, receiving the first DCI that includes an index indicates a first RB subset of the set of RBs in which the second DCI is communicated.

In some cases, the second DCI is received within one of the first shared data channel occasion or the second shared data channel occasion based on an aggregation level of the first DCI. In some cases, the second DCI is received within one of the first shared data channel occasion or the second shared data channel occasion based on a starting index of a CCE of the first DCI. In some cases, the second DCI is received within one of the first shared data channel occasion or the second shared data channel occasion based on a payload size of the second DCI that corresponds to the first DCI.

In some cases, the second DCI is received within one of the first shared data channel occasion or the second shared data channel occasion based on an index indicated in the first DCI. In some cases, the first DCI and the second DCI are received within a same transmission time interval.

The uplink transmission manager 720 may transmit an uplink transmission in accordance with the first DCI and the second DCI.

The blind decoding manager 725 may perform blind decoding of one or more search spaces in the CORESET to decode the first DCI, where the shared data channel occasion is decoded based on successful decoding of the first DCI.

The code rate manager 730 may derive the subset of the set of RBs in which the second DCI is communicated based on the code rate.

The PDSCH manager 735 may identify one or more configurations associated with the PDSCH, such as rate-matching configurations. In some cases, the second DCI is rate-matched on at least a subset of a set of RBs allocated for the shared data channel occasion.

The polar decoding manager 740 may perform polar decoding on the CORESET to obtain the first DCI. In some examples, the polar decoding manager 740 may perform polar decoding on the shared data channel occasion to obtain the second DCI.

The LDPC decoding manager 745 may perform low density parity check decoding on the shared data channel occasion to obtain the second DCI.

FIG. 8 shows a diagram of a system 800 including a device 805 that supports DCI for uplink scheduling in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive control signaling configuring the user equipment with a shared data channel occasion, receive first DCI via a CORESET, receive second DCI via the shared data channel occasion, and transmit an uplink transmission in accordance with the first DCI and the second DCI.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random-access memory (RAM) and read-only memory (ROM). The memory 830 may store computer-readable, computer-executable code 835 including instructions that, when executed, cause the processor to perform various functions described herein. In some cases, the memory 830 may contain, among other things, a basic I/O system (BIOS) which may control basic hardware or software operation such as the interaction with peripheral components or devices.

The processor 840 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting DCI for uplink scheduling).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

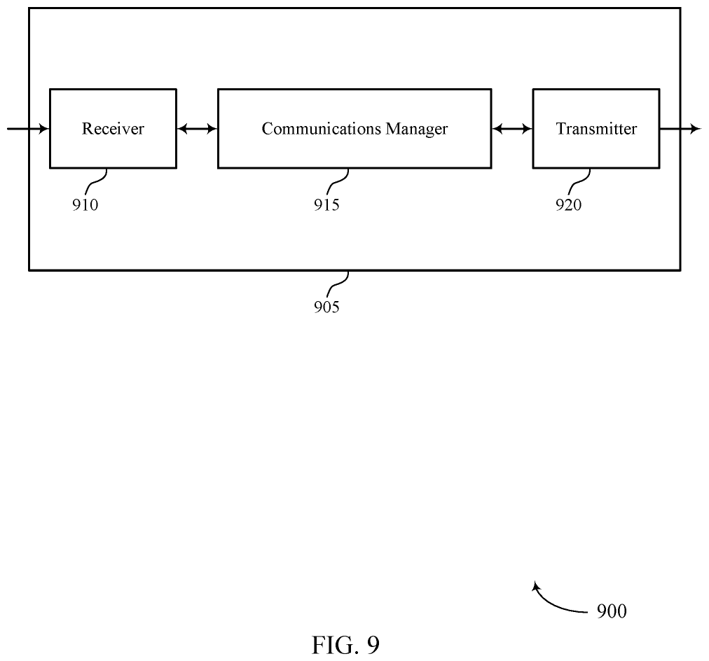

FIG. 9 shows a block diagram 900 of a device 905 that supports DCI for uplink scheduling in accordance with aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

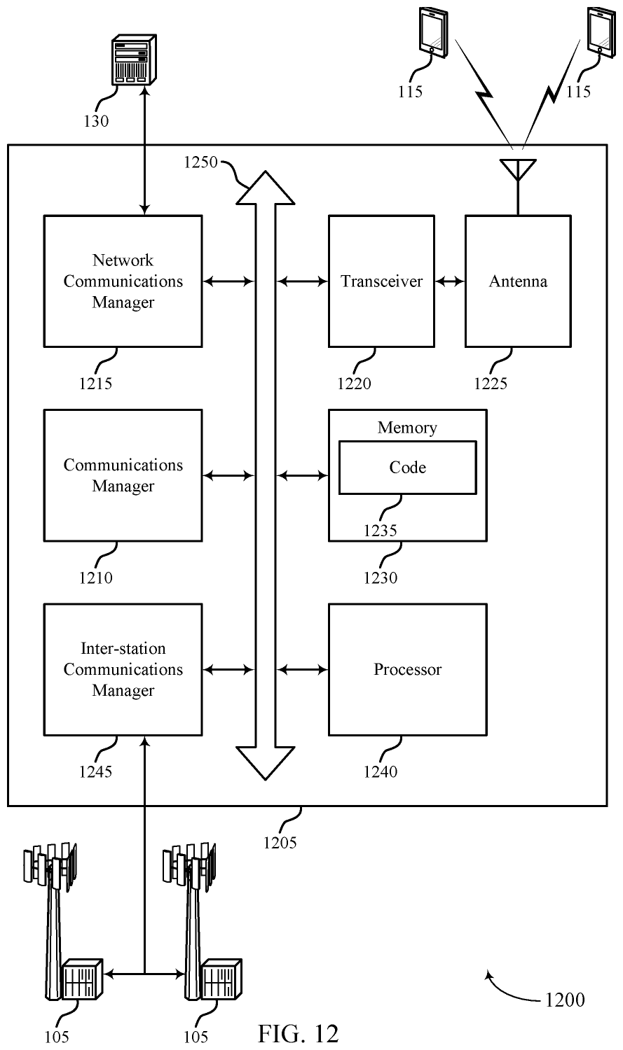

The receiver 910 may receive information such as packets, user data, or control information associated with various information channels (e.g., control channels, data channels, and information related to DCI for uplink scheduling, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may transmit control signaling configuring the user equipment with a shared data channel occasion, transmit first DCI via a CORESET, transmit second DCI via the shared data channel occasion, and receive an uplink transmission in accordance with the first DCI and the second DCI. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

The device 905 may realize one or more advantages by implementing some of the techniques described herein. For example, by configuring a UE to receive multiple related DCIs, where a second DCI is based on a first DCI, may enable the device 905 to provide more control information and configure more at the UE. In some examples, greater capacity for control information may enable the device 905 to more efficiently allocate resources, improving spectral efficiency, while also increasing the achievable capacity and throughput of the device 905 and the UE.

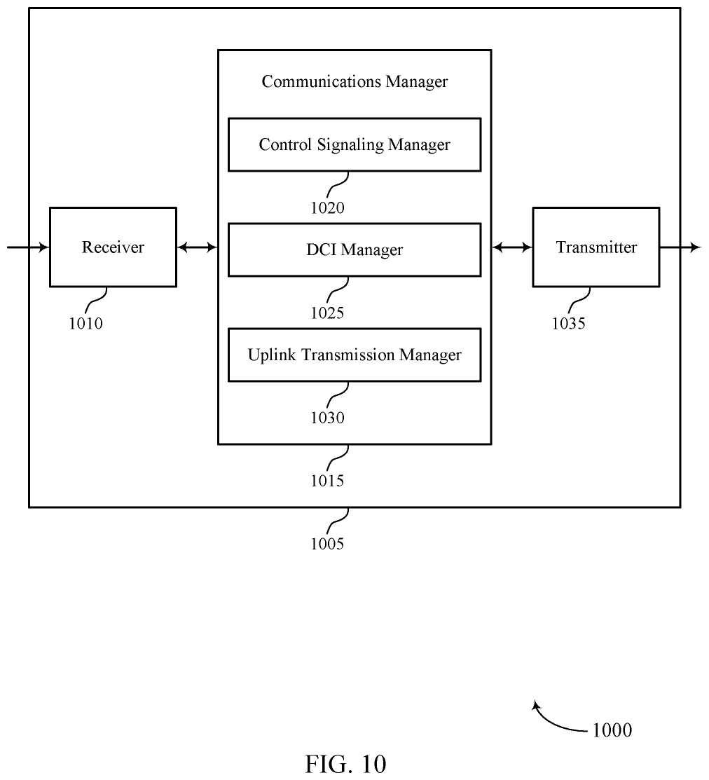

FIG. 10 shows a block diagram 1000 of a device 1005 that supports DCI for uplink scheduling in accordance with aspects of the present disclosure. The device 1005 may be an example of aspects of a device 905, or a base station 105 as described herein. The device 1005 may include a receiver 1010, a communications manager 1015, and a transmitter 1035. The device 1005 may also include a processor. Each of these components may be in communication with one another (e.g., via one or more buses).

The receiver 1010 may receive information such as packets, user data, or control information associated with various information channels (e.g., control channels, data channels, and information related to DCI for uplink scheduling, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a control signaling manager 1020, a DCI manager 1025, and an uplink transmission manager 1030. The communications manager 1015 may be an example of aspects of the communications manager 1210 described herein.

The control signaling manager 1020 may transmit control signaling configuring the user equipment with a shared data channel occasion. The DCI manager 1025 may transmit first DCI via a CORESET and transmit second DCI via the shared data channel occasion. The uplink transmission manager 1030 may receive an uplink transmission in accordance with the first DCI and the second DCI.

The transmitter 1035 may transmit signals generated by other components of the device 1005. In some examples, the transmitter 1035 may be collocated with a receiver 1010 in a transceiver module. For example, the transmitter 1035 may be an example of aspects of the transceiver 1220 described with reference to FIG. 12. The transmitter 1035 may utilize a single antenna or a set of antennas.

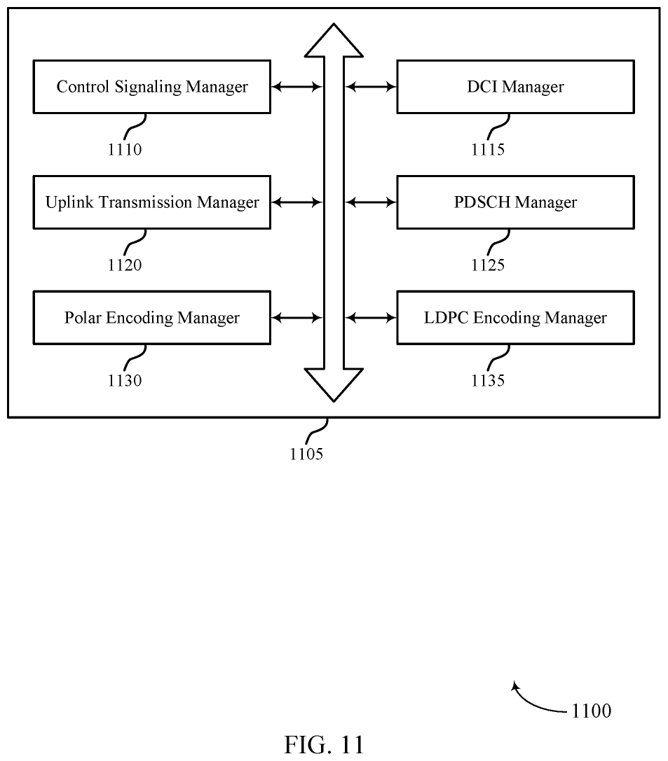

FIG. 11 shows a block diagram 1100 of a communications manager 1105 that supports DCI for uplink scheduling in accordance with aspects of the present disclosure. The communications manager 1105 may be an example of aspects of a communications manager 915, a communications manager 1015, or a communications manager 1210 described herein. The communications manager 1105 may include a control signaling manager 1110, a DCI manager 1115, an uplink transmission manager 1120, a PDSCH manager 1125, a polar encoding manager 1130, and a LDPC encoding manager 1135. Each of these modules may communicate, directly or indirectly, with one another (e.g., via one or more buses).

The control signaling manager 1110 may transmit control signaling configuring the user equipment with a shared data channel occasion.

In some examples, the control signaling manager 1110 may transmit the control signaling that indicates a time domain resource allocation, a frequency domain resource allocation, or both, for the shared data channel occasion. In some examples, the control signaling manager 1110 may transmit the control signaling that indicates the time domain resource allocation that indicates one or more symbol periods, the frequency domain resource allocation that indicates one or more RBs, or both, for the shared data channel occasion. In some examples, the control signaling manager 1110 may transmit the control signaling that indicates an offset for the shared data channel occasion relative to a location of the first DCI in the CORESET, where the second DCI is transmitted based on the offset.

In some examples, the control signaling manager 1110 may transmit the control signaling that indicates a modulation order configured for the shared data channel occasion, where the second DCI is transmitted based on the modulation order. In some examples, the control signaling manager 1110 may transmit the control signaling that indicates a demodulation reference signal configuration configured for the shared data channel occasion, where the second DCI is transmitted based on the demodulation reference signal configuration. In some examples, the control signaling manager 1110 may transmit the control signaling indicating that the second DCI is communicated within at least a subset of a set of RBs allocated for the shared data channel occasion.

In some examples, the control signaling manager 1110 may transmit the control signaling indicating that the second DCI is communicated within all of the set of RBs allocated for the shared data channel occasion. In some examples, the control signaling manager 1110 may transmit the control signaling that indicates a code rate configured for the shared data channel occasion. In some examples, the control signaling manager 1110 may transmit the control signaling configuring the user equipment with a first shared data channel occasion and a second shared data channel occasion within a shared data channel, where the second DCI is transmitted within one of the first shared data channel occasion or the second shared data channel occasion based on the first DCI.

The DCI manager 1115 may transmit first DCI via a CORESET. In some examples, the DCI manager 1115 may transmit second DCI via the shared data channel occasion. In some examples, the DCI manager 1115 may transmit the second DCI that has a payload size that is dependent on the first DCI.

In some examples, transmitting the first DCI that includes an index that indicates a first RB subset of the set of RBs in which the second DCI is communicated. In some cases, the second DCI is transmitted within one of the first shared data channel occasion or the second shared data channel occasion based on an aggregation level of the first DCI.

In some cases, the second DCI is transmitted within one of the first shared data channel occasion or the second shared data channel occasion based on a starting index of a CCE of the first DCI. In some cases, the second DCI is transmitted within one of the first shared data channel occasion or the second shared data channel occasion based on a payload size of the second DCI that corresponds to the first DCI.

In some cases, the second DCI is transmitted within one of the first shared data channel occasion or the second shared data channel occasion based on an index indicated in the first DCI. In some cases, the first DCI and the second DCI are transmitted within a same transmission time interval.

The uplink transmission manager 1120 may receive an uplink transmission in accordance with the first DCI and the second DCI.

The PDSCH manager 1125 may determine one or more configurations associated with a PDSCH, such as a rate-matching configuration. In some cases, the second DCI is rate-matched on at least a subset of a set of RBs allocated for the shared data channel occasion.

The polar encoding manager 1130 may perform polar encoding of the first DCI to generate a first one or more codewords, where transmitting the first DCI includes transmitting the first one or more codewords. In some examples, performing polar encoding of the second DCI to generate a second one or more codewords, where transmitting the second DCI includes transmitting the second one or more codewords.

The LDPC encoding manager 1135 may perform low density parity check encoding of the second DCI to generate a second one or more codewords, where transmitting the second DCI includes transmitting the second one or more codewords.

FIG. 12 shows a diagram of a system 1200 including a device 1205 that supports DCI for uplink scheduling in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The communications manager 1210 may transmit control signaling configuring the user equipment with a shared data channel occasion, transmit first DCI via a CORESET, transmit second DCI via the shared data channel occasion, and receive an uplink transmission in accordance with the first DCI and the second DCI.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described above. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting DCI for uplink scheduling).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

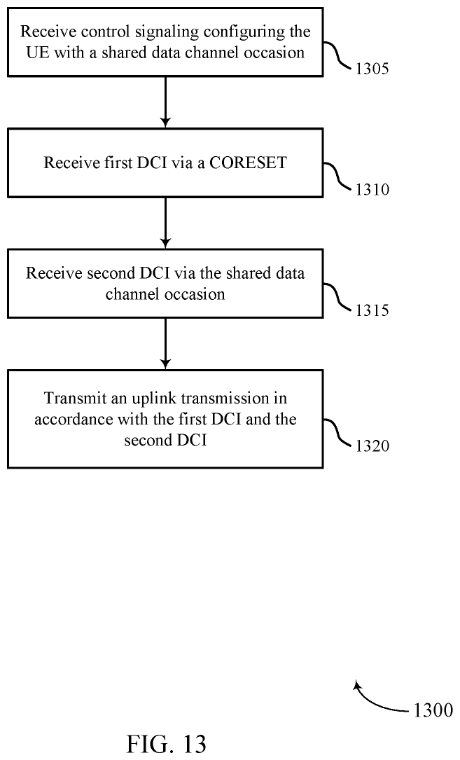

FIG. 13 shows a flowchart illustrating a method 1300 that supports DCI for uplink scheduling in accordance with aspects of the present disclosure. The operations of method 1300 may be implemented by a UE 115 or its components as described herein. For example, the operations of method 1300 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1305, the UE may receive control signaling configuring the UE with a shared data channel occasion. The operations of 1305 may be performed according to the methods described herein. In some examples, aspects of the operations of 1305 may be performed by a control signaling manager as described with reference to FIGS. 5 through 8.

At 1310, the UE may receive first DCI via a CORESET. The operations of 1310 may be performed according to the methods described herein. In some examples, aspects of the operations of 1310 may be performed by a DCI manager as described with reference to FIGS. 5 through 8.

At 1315, the UE may receive second DCI via the shared data channel occasion. The operations of 1315 may be performed according to the methods described herein. In some examples, aspects of the operations of 1315 may be performed by a DCI manager as described with reference to FIGS. 5 through 8.

At 1320, the UE may transmit an uplink transmission in accordance with the first DCI and the second DCI. The operations of 1320 may be performed according to the methods described herein. In some examples, aspects of the operations of 1320 may be performed by an uplink transmission manager as described with reference to FIGS. 5 through 8.

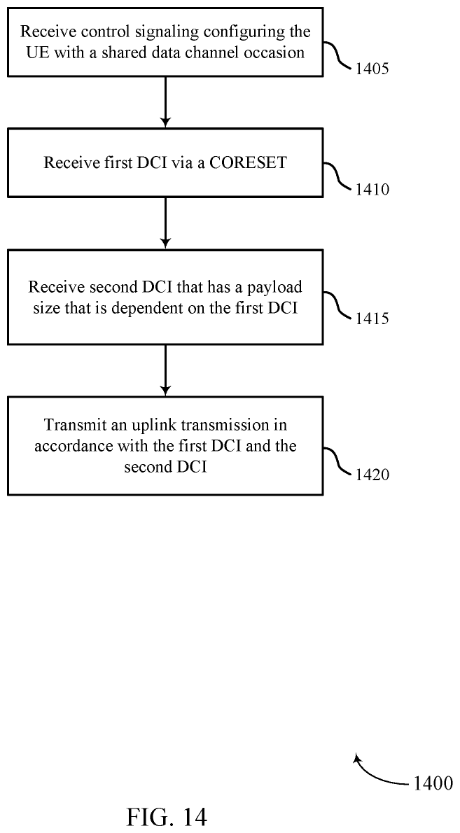

FIG. 14 shows a flowchart illustrating a method 1400 that supports DCI for uplink scheduling in accordance with aspects of the present disclosure. The operations of method 1400 may be implemented by a UE 115 or its components as described herein. For example, the operations of method 1400 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1405, the UE may receive control signaling configuring the UE with a shared data channel occasion. The operations of 1405 may be performed according to the methods described herein. In some examples, aspects of the operations of 1405 may be performed by a control signaling manager as described with reference to FIGS. 5 through 8.

At 1410, the UE may receive first DCI via a CORESET. The operations of 1410 may be performed according to the methods described herein. In some examples, aspects of the operations of 1410 may be performed by a DCI manager as described with reference to FIGS. 5 through 8.

At 1415, the UE may receive second DCI that has a payload size that is dependent on the first DCI. The operations of 1415 may be performed according to the methods described herein. In some examples, aspects of the operations of 1415 may be performed by a DCI manager as described with reference to FIGS. 5 through 8.

At 1420, the UE may transmit an uplink transmission in accordance with the first DCI and the second DCI. The operations of 1420 may be performed according to the methods described herein. In some examples, aspects of the operations of 1420 may be performed by an uplink transmission manager as described with reference to FIGS. 5 through 8.

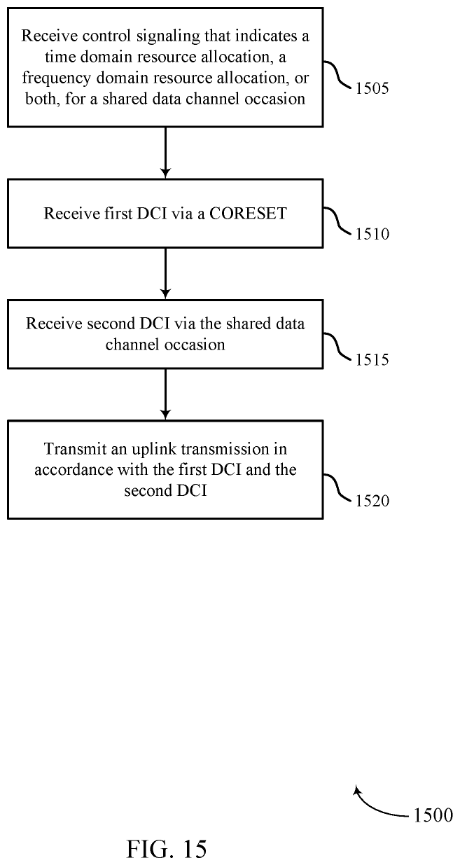

FIG. 15 shows a flowchart illustrating a method 1500 that supports DCI for uplink scheduling in accordance with aspects of the present disclosure. The operations of method 1500 may be implemented by a UE 115 or its components as described herein. For example, the operations of method 1500 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1505, the UE may receive control signaling that indicates a time domain resource allocation, a frequency domain resource allocation, or both, for a shared data channel occasion. The operations of 1505 may be performed according to the methods described herein. In some examples, aspects of the operations of 1505 may be performed by a control signaling manager as described with reference to FIGS. 5 through 8.

At 1510, the UE may receive first DCI via a CORESET. The operations of 1510 may be performed according to the methods described herein. In some examples, aspects of the operations of 1510 may be performed by a DCI manager as described with reference to FIGS. 5 through 8.

At 1515, the UE may receive second DCI via the shared data channel occasion. The operations of 1515 may be performed according to the methods described herein. In some examples, aspects of the operations of 1515 may be performed by a DCI manager as described with reference to FIGS. 5 through 8.

At 1520, the UE may transmit an uplink transmission in accordance with the first DCI and the second DCI. The operations of 1520 may be performed according to the methods described herein. In some examples, aspects of the operations of 1520 may be performed by an uplink transmission manager as described with reference to FIGS. 5 through 8.

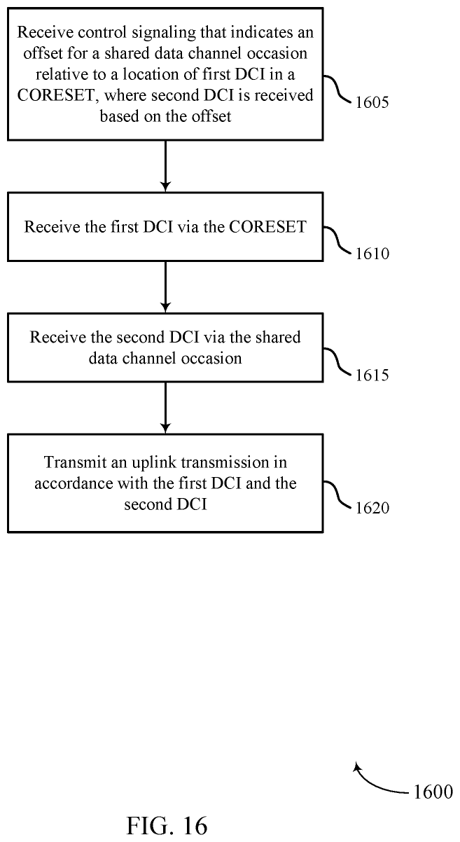

FIG. 16 shows a flowchart illustrating a method 1600 that supports DCI for uplink scheduling in accordance with aspects of the present disclosure. The operations of method 1600 may be implemented by a UE 115 or its components as described herein. For example, the operations of method 1600 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1605, the UE may receive control signaling that indicates an offset for a shared data channel occasion relative to a location of first DCI in a CORESET, where second DCI is received based on the offset. The operations of 1605 may be performed according to the methods described herein. In some examples, aspects of the operations of 1610 may be performed by a control signaling manager as described with reference to FIGS. 5 through 8.

At 1610, the UE may receive the first DCI via the CORESET. The operations of 1610 may be performed according to the methods described herein. In some examples, aspects of the operations of 1610 may be performed by a DCI manager as described with reference to FIGS. 5 through 8.

At 1615, the UE may receive the second DCI via the shared data channel occasion. The operations of 1615 may be performed according to the methods described herein. In some examples, aspects of the operations of 1615 may be performed by a DCI manager as described with reference to FIGS. 5 through 8.

At 1620, the UE may transmit an uplink transmission in accordance with the first DCI and the second DCI. The operations of 1620 may be performed according to the methods described herein. In some examples, aspects of the operations of 1620 may be performed by an uplink transmission manager as described with reference to FIGS. 5 through 8.

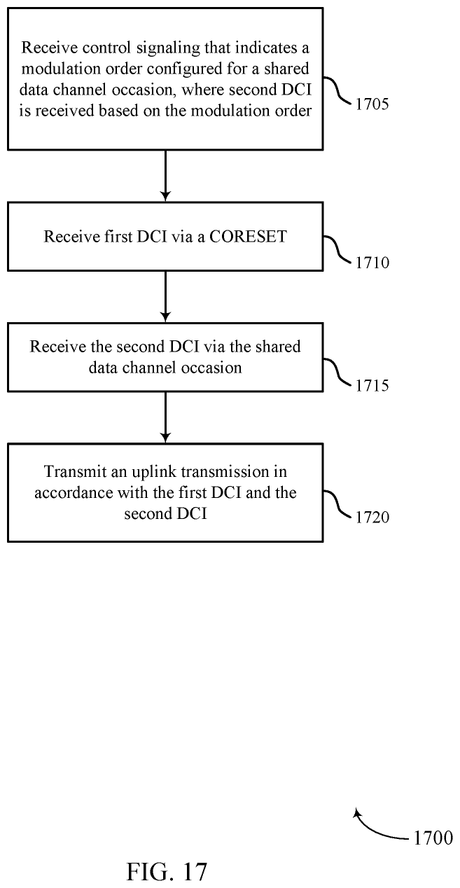

FIG. 17 shows a flowchart illustrating a method 1700 that supports DCI for uplink scheduling in accordance with aspects of the present disclosure. The operations of method 1700 may be implemented by a UE 115 or its components as described herein. For example, the operations of method 1700 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1705, the UE may receive control signaling that indicates a modulation order configured for a shared data channel occasion, where second DCI is received based on the modulation order. The operations of 1710 may be performed according to the methods described herein. In some examples, aspects of the operations of 1710 may be performed by a control signaling manager as described with reference to FIGS. 5 through 8.

At 1710, the UE may receive first DCI via a CORESET. The operations of 1710 may be performed according to the methods described herein. In some examples, aspects of the operations of 1710 may be performed by a DCI manager as described with reference to FIGS. 5 through 8.

At 1715, the UE may receive the second DCI via the shared data channel occasion. The operations of 1715 may be performed according to the methods described herein. In some examples, aspects of the operations of 1715 may be performed by a DCI manager as described with reference to FIGS. 5 through 8.

At 1720, the UE may transmit an uplink transmission in accordance with the first DCI and the second DCI. The operations of 1720 may be performed according to the methods described herein. In some examples, aspects of the operations of 1720 may be performed by an uplink transmission manager as described with reference to FIGS. 5 through 8.

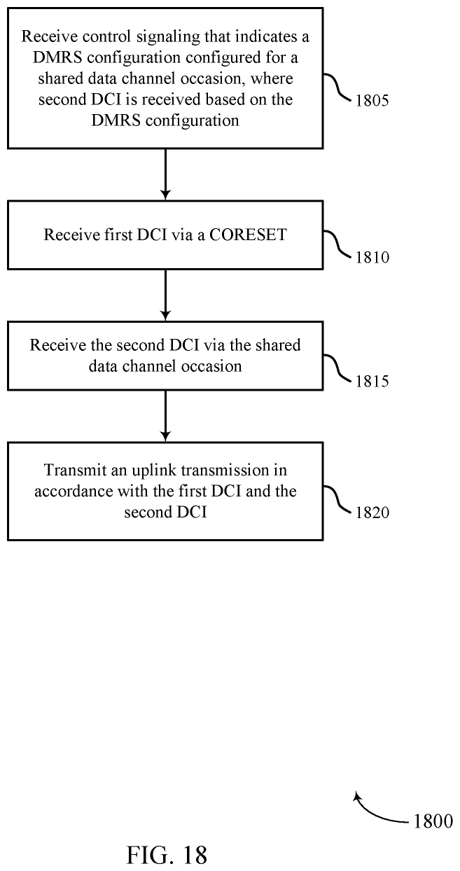

FIG. 18 shows a flowchart illustrating a method 1800 that supports DCI for uplink scheduling in accordance with aspects of the present disclosure. The operations of method 1800 may be implemented by a UE 115 or its components as described herein. For example, the operations of method 1800 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1805, the UE may receive control signaling that indicates a DMRS configuration configured for a shared data channel occasion, where second DCI is received based on the DMRS configuration. The operations of 1805 may be performed according to the methods described herein. In some examples, aspects of the operations of 1805 may be performed by a control signaling manager as described with reference to FIGS. 5 through 8.

At 1810, the UE may receive first DCI via a CORESET. The operations of 1810 may be performed according to the methods described herein. In some examples, aspects of the operations of 1810 may be performed by a DCI manager as described with reference to FIGS. 5 through 8.

At 1815, the UE may receive the second DCI via the shared data channel occasion. The operations of 1815 may be performed according to the methods described herein. In some examples, aspects of the operations of 1815 may be performed by a DCI manager as described with reference to FIGS. 5 through 8.

At 1820, the UE may transmit an uplink transmission in accordance with the first DCI and the second DCI. The operations of 1820 may be performed according to the methods described herein. In some examples, aspects of the operations of 1820 may be performed by an uplink transmission manager as described with reference to FIGS. 5 through 8.

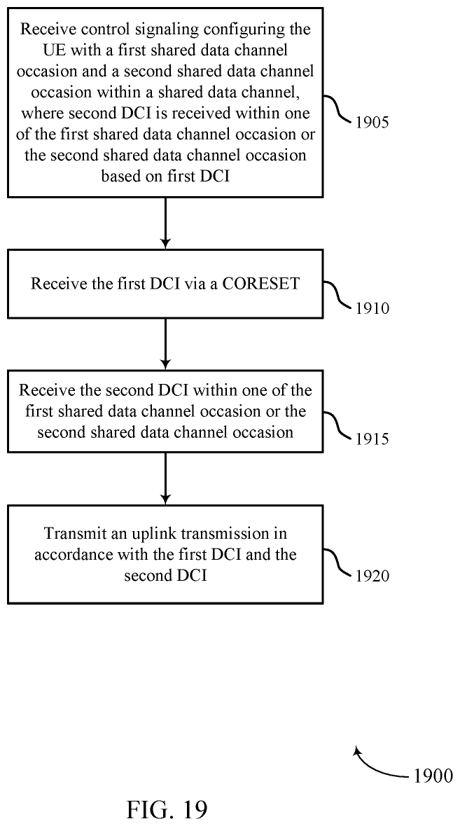

FIG. 19 shows a flowchart illustrating a method 1900 that supports DCI for uplink scheduling in accordance with aspects of the present disclosure. The operations of method 1900 may be implemented by a UE 115 or its components as described herein. For example, the operations of method 1900 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1905, the UE may receive control signaling configuring the UE with a first shared data channel occasion and a second shared data channel occasion within a shared data channel, where second DCI is received within one of the first shared data channel occasion or the second shared data channel occasion based on first DCI. The operations of 1905 may be performed according to the methods described herein. In some examples, aspects of the operations of 1905 may be performed by a control signaling manager as described with reference to FIGS. 5 through 8.

At 1910, the UE may receive the first DCI via a CORESET. The operations of 1910 may be performed according to the methods described herein. In some examples, aspects of the operations of 1910 may be performed by a DCI manager as described with reference to FIGS. 5 through 8.

At 1915, the UE may receive the second DCI within one of the first shared data channel occasion or the second shared data channel occasion. The operations of 1915 may be performed according to the methods described herein. In some examples, aspects of the operations of 1915 may be performed by a DCI manager as described with reference to FIGS. 5 through 8.

At 1920, the UE may transmit an uplink transmission in accordance with the first DCI and the second DCI. The operations of 1920 may be performed according to the methods described herein. In some examples, aspects of the operations of 1920 may be performed by an uplink transmission manager as described with reference to FIGS. 5 through 8.

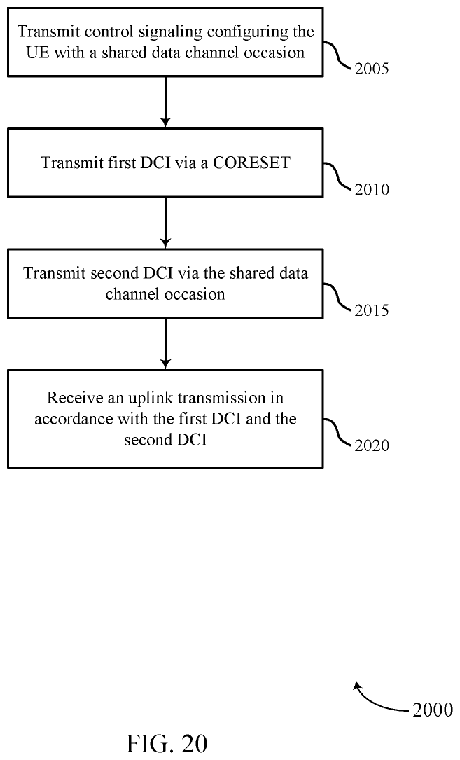

FIG. 20 shows a flowchart illustrating a method 2000 that supports DCI for uplink scheduling in accordance with aspects of the present disclosure. The operations of method 2000 may be implemented by a base station 105 or its components as described herein. For example, the operations of method 2000 may be performed by a communications manager as described with reference to FIGS. 9 through 12. In some examples, a base station may execute a set of instructions to control the functional elements of the base station to perform the functions described below. Additionally or alternatively, a base station may perform aspects of the functions described below using special-purpose hardware.

At 2005, the base station may transmit control signaling configuring the UE with a shared data channel occasion. The operations of 2005 may be performed according to the methods described herein. In some examples, aspects of the operations of 2005 may be performed by a control signaling manager as described with reference to FIGS. 9 through 12.

At 2010, the base station may transmit first DCI via a CORESET. The operations of 2010 may be performed according to the methods described herein. In some examples, aspects of the operations of 2010 may be performed by a DCI manager as described with reference to FIGS. 9 through 12.

At 2015, the base station may transmit second DCI via the shared data channel occasion. The operations of 2015 may be performed according to the methods described herein. In some examples, aspects of the operations of 2015 may be performed by a DCI manager as described with reference to FIGS. 9 through 12.

At 2020, the base station may receive an uplink transmission in accordance with the first DCI and the second DCI. The operations of 2020 may be performed according to the methods described herein. In some examples, aspects of the operations of 2020 may be performed by an uplink transmission manager as described with reference to FIGS. 9 through 12.

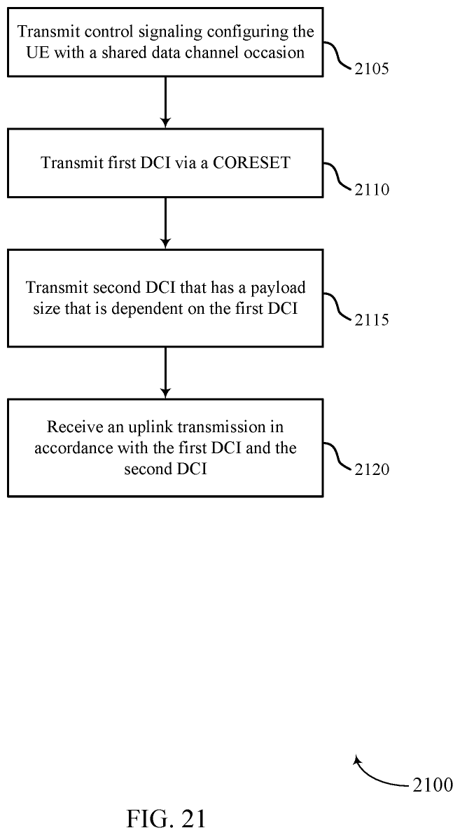

FIG. 21 shows a flowchart illustrating a method 2100 that supports DCI for uplink scheduling in accordance with aspects of the present disclosure. The operations of method 2100 may be implemented by a base station 105 or its components as described herein. For example, the operations of method 2100 may be performed by a communications manager as described with reference to FIGS. 9 through 12. In some examples, a base station may execute a set of instructions to control the functional elements of the base station to perform the functions described below. Additionally or alternatively, a base station may perform aspects of the functions described below using special-purpose hardware.

At 2105, the base station may transmit control signaling configuring the UE with a shared data channel occasion. The operations of 2105 may be performed according to the methods described herein. In some examples, aspects of the operations of 2105 may be performed by a control signaling manager as described with reference to FIGS. 9 through 12.

At 2110, the base station may transmit first DCI via a CORESET. The operations of 2110 may be performed according to the methods described herein. In some examples, aspects of the operations of 2110 may be performed by a DCI manager as described with reference to FIGS. 9 through 12.

At 2115, the base station may transmit second DCI that has a payload size that is dependent on the first DCI. The operations of 2115 may be performed according to the methods described herein. In some examples, aspects of the operations of 2115 may be performed by a DCI manager as described with reference to FIGS. 9 through 12.

At 2120, the base station may receive an uplink transmission in accordance with the first DCI and the second DCI. The operations of 2120 may be performed according to the methods described herein. In some examples, aspects of the operations of 2120 may be performed by an uplink transmission manager as described with reference to FIGS. 9 through 12.

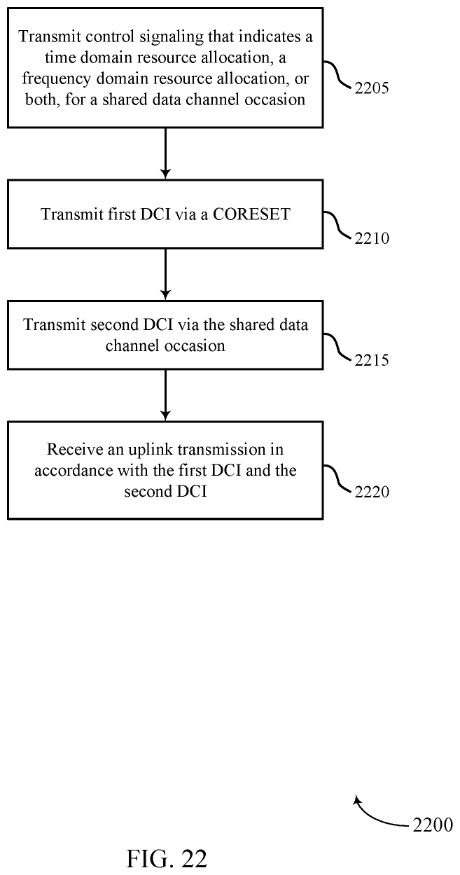

FIG. 22 shows a flowchart illustrating a method 2200 that supports DCI for uplink scheduling in accordance with aspects of the present disclosure. The operations of method 2200 may be implemented by a base station 105 or its components as described herein. For example, the operations of method 2200 may be performed by a communications manager as described with reference to FIGS. 9 through 12. In some examples, a base station may execute a set of instructions to control the functional elements of the base station to perform the functions described below. Additionally or alternatively, a base station may perform aspects of the functions described below using special-purpose hardware.

At 2205, the base station may transmit control signaling that indicates a time domain resource allocation, a frequency domain resource allocation, or both, for a shared data channel occasion. The operations of 2205 may be performed according to the methods described herein. In some examples, aspects of the operations of 2205 may be performed by a control signaling manager as described with reference to FIGS. 9 through 12.

At 2210, the base station may transmit first DCI via a CORESET. The operations of 2210 may be performed according to the methods described herein. In some examples, aspects of the operations of 2210 may be performed by a DCI manager as described with reference to FIGS. 9 through 12.

At 2215, the base station may transmit second DCI via the shared data channel occasion. The operations of 2215 may be performed according to the methods described herein. In some examples, aspects of the operations of 2215 may be performed by a DCI manager as described with reference to FIGS. 9 through 12.

At 2225, the base station may receive an uplink transmission in accordance with the first DCI and the second DCI. The operations of 2225 may be performed according to the methods described herein. In some examples, aspects of the operations of 2225 may be performed by an uplink transmission manager as described with reference to FIGS. 9 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications by a user equipment, comprising:
receiving control signaling configuring the user equipment with a shared data channel occasion;
receiving first downlink control information via a control resource set;
receiving second downlink control information via the shared data channel occasion; and
transmitting an uplink transmission in accordance with the first downlink control information and the second downlink control information.

2. The method of claim 1, wherein receiving the second downlink control information comprises:
receiving the second downlink control information that has a payload size that is dependent on the first downlink control information.

3. The method of claim 1, wherein receiving the control signaling comprises:
receiving the control signaling that indicates a time domain resource allocation, a frequency domain resource allocation, or both, for the shared data channel occasion.

4. The method of claim 3, wherein receiving the control signaling comprises:
receiving the control signaling that indicates the time domain resource allocation that indicates one or more symbol periods, the frequency domain resource allocation that indicates one or more resource blocks, or both, for the shared data channel occasion.

5. The method of claim 1, wherein receiving the control signaling comprises:
receiving the control signaling that indicates an offset for the shared data channel occasion relative to a location of the first downlink control information in the control resource set, wherein the second downlink control information is received based at least in part on the offset.

6. The method of claim 1, wherein receiving the control signaling comprises:
receiving the control signaling that indicates a modulation order configured for the shared data channel occasion, wherein the second downlink control information is received based at least in part on the modulation order.

7. The method of claim 1, wherein receiving the control signaling comprises:
receiving the control signaling that indicates a demodulation reference signal configuration configured for the shared data channel occasion, wherein the second downlink control information is received based at least in part on the demodulation reference signal configuration.

8. The method of claim 1, wherein receiving the first downlink control information comprises:
performing blind decoding of one or more search spaces in the control resource set to decode the first downlink control information, wherein the shared data channel occasion is decoded based at least in part on successful decoding of the first downlink control information.

9. The method of claim 1, wherein receiving the control signaling comprises:
receiving the control signaling indicating that the second downlink control information is communicated within at least a subset of a plurality of resource blocks allocated for the shared data channel occasion.

10. The method of claim 9, wherein receiving the control signaling comprises:
receiving the control signaling indicating that the second downlink control information is communicated within all of the plurality of resource blocks allocated for the shared data channel occasion.

11. The method of claim 9, wherein receiving the first downlink control information comprises:
receiving the first downlink control information that comprises an index that indicates a first resource block subset of the plurality of resource blocks in which the second downlink control information is communicated.

12. The method of claim 9, wherein receiving the control signaling comprises:
receiving the control signaling that indicates a code rate configured for the shared data channel occasion; and
deriving the subset of the plurality of resource blocks in which the second downlink control information is communicated based at least in part on the code rate.

13. The method of claim 1, wherein the second downlink control information is rate-matched on at least a subset of a plurality of resource blocks allocated for the shared data channel occasion.

14. The method of claim 1, wherein receiving the control signaling configuring the user equipment with the shared data channel occasion comprises:
receiving the control signaling configuring the user equipment with a first shared data channel occasion and a second shared data channel occasion within a shared data channel, wherein the second downlink control information is received within one of the first shared data channel occasion or the second shared data channel occasion based at least in part on the first downlink control information.

15. The method of claim 14, wherein the second downlink control information is received within one of the first shared data channel occasion or the second shared data channel occasion based at least in part on an aggregation level of the first downlink control information.

16. The method of claim 14, wherein the second downlink control information is received within one of the first shared data channel occasion or the second shared data channel occasion based at least in part on a starting index of a control channel element of the first downlink control information.

17. The method of claim 14, wherein the second downlink control information is received within one of the first shared data channel occasion or the second shared data channel occasion based at least in part on a payload size of the second downlink control information that corresponds to the first downlink control information.

18. The method of claim 14, wherein the second downlink control information is received within one of the first shared data channel occasion or the second shared data channel occasion based at least in part on an index indicated in the first downlink control information.

19. The method of claim 1, further comprising:
performing polar decoding on the control resource set to obtain the first downlink control information; and
performing polar decoding on the shared data channel occasion to obtain the second downlink control information.

20. The method of claim 1, further comprising:
performing polar decoding on the control resource set to obtain the first downlink control information; and
performing low density parity check decoding on the shared data channel occasion to obtain the second downlink control information.

21. The method of claim 1, wherein the first downlink control information and the second downlink control information are received within a same transmission time interval.

22. A method for wireless communications by a base station, comprising:
transmitting control signaling configuring a user equipment with a shared data channel occasion;
transmitting first downlink control information via a control resource set;
transmitting second downlink control information via the shared data channel occasion; and
receiving an uplink transmission in accordance with the first downlink control information and the second downlink control information.

23. The method of claim 22, wherein transmitting the second downlink control information comprises:
transmitting the second downlink control information that has a payload size that is dependent on the first downlink control information.

24. The method of claim 22, wherein transmitting the control signaling comprises:
transmitting the control signaling that indicates a time domain resource allocation, a frequency domain resource allocation, or both, for the shared data channel occasion.

25. The method of claim 24, wherein transmitting the control signaling comprises:
transmitting the control signaling that indicates the time domain resource allocation that indicates one or more symbol periods, the frequency domain resource allocation that indicates one or more resource blocks, or both, for the shared data channel occasion.

26. The method of claim 22, wherein transmitting the control signaling comprises:
transmitting the control signaling that indicates an offset for the shared data channel occasion relative to a location of the first downlink control information in the control resource set, wherein the second downlink control information is transmitted based at least in part on the offset.

27. The method of claim 22, wherein transmitting the control signaling comprises:
transmitting the control signaling that indicates a modulation order configured for the shared data channel occasion, wherein the second downlink control information is transmitted based at least in part on the modulation order.

28. The method of claim 22, wherein transmitting the control signaling comprises:
transmitting the control signaling that indicates a demodulation reference signal configuration configured for the shared data channel occasion, wherein the second downlink control information is transmitted based at least in part on the demodulation reference signal configuration.

29. The method of claim 22, wherein transmitting the control signaling comprises:
transmitting the control signaling indicating that the second downlink control information is communicated within at least a subset of a plurality of resource blocks allocated for the shared data channel occasion.

30. The method of claim 29, wherein transmitting the control signaling comprises:
transmitting the control signaling indicating that the second downlink control information is communicated within all of the plurality of resource blocks allocated for the shared data channel occasion.

31. The method of claim 29, wherein transmitting the first downlink control information comprises:
transmitting the first downlink control information that comprises an index that indicates a first resource block subset of the plurality of resource blocks in which the second downlink control information is communicated.

32. The method of claim 29, wherein transmitting the control signaling comprises:
transmitting the control signaling that indicates a code rate configured for the shared data channel occasion.

33-41. (canceled)

42. An apparatus for wireless communications by a user equipment, comprising:
a processor,
memory coupled with the processor; and
instructions stored in the memory and executable by the processor to cause the apparatus to:
receive control signaling configuring the user equipment with a shared data channel occasion;
receive first downlink control information via a control resource set;
receive second downlink control information via the shared data channel occasion; and
transmit an uplink transmission in accordance with the first downlink control information and the second downlink control information.

43-62. (canceled)

63. An apparatus for wireless communications by a base station, comprising:
a processor,
memory coupled with the processor; and
instructions stored in the memory and executable by the processor to cause the apparatus to:
transmit control signaling configuring a user equipment with a shared data channel occasion;
transmit first downlink control information via a control resource set;
transmit second downlink control information via the shared data channel occasion; and
receive an uplink transmission in accordance with the first downlink control information and the second downlink control information.

64-82. (canceled)

83. An apparatus for wireless communications by a user equipment, comprising:
means for receiving control signaling configuring the user equipment with a shared data channel occasion;
means for receiving first downlink control information via a control resource set;
means for receiving second downlink control information via the shared data channel occasion; and
means for transmitting an uplink transmission in accordance with the first downlink control information and the second downlink control information.

84-86. (canceled)
